(19) United States
(12) Patent Application Publication
(10) Pub. No.: US 2025/0010246 A1
(43) Pub. Date: Jan. 9, 2025

(54) APPARATUSES ADN METHODS FOR FILTRATION

(71) Applicant: ALIT BIOTECH (SHANGHAI) CO., LTD., Shanghai (CN)

(72) Inventors: Guoqian XU, Shanghai (CN); Rui CHEN, Shanghai (CN)

(73) Assignee: ALIT BIOTECH (SHANGHAI) CO., LTD., Shanghai (CN)

(21) Appl. No.: 18/766,612

(22) Filed: Jul. 8, 2024

(30) Foreign Application Priority Data
Jul. 7, 2023 (CN) 202310834071.0
Jan. 8, 2024 (CN) 202410026415.X
Jan. 8, 2024 (CN) 202420034608.5

(51) Int. Cl. B01D 69/10

(52) U.S. Cl. CPC B01D 69/10; B01D 2313/12

(57) ABSTRACT

The present disclosure relates to an apparatus and a method for filtration. The apparatus for filtration may include at least one filtration layer and at least one flow-through layer disposed along a filtration direction of the filtration layer. One of the at least one flow-through layer may include at least one first support member and at least one first flow channel. The at least one first flow channel may be configured for a liquid to flow, and the at least one first support member may define the at least one first flow channel.

### CROSS-REFERENCE TO RELATED APPLICATIONS

This application claims priority to Chinese patent application No. 202310834071.0, filed on Jul. 7, 2023, claims priority to Chinese patent application No. 202420034608.5, filed on Jan. 8, 2024, and claims priority to Chinese patent application No. 202410026415.X, filed on Jan. 8, 2024, and the entirety of each of which is fully incorporated herein by reference.

### TECHNICAL FIELD

The present disclosure relates to the technical field of biological devices, and in particular, to an apparatus and a method for filtration.

### BACKGROUND

Membrane separation technology refers to a process of using filtration membranes to separate and purify liquids or gases. Membrane filtration technology is widely applied in water treatment, food processing, and biotechnology fields. Commonly used membranes in tangential flow filtration mainly include a rolled membrane, a hollow fiber membrane, and a plate membrane. However, both the rolled membrane and the hollow fiber membrane have disadvantages. The rolled membrane requires very high flow rates, leading to high energy consumption and being prone to leakage at the ends, resulting in their gradual phase-out in the biomedical field. The hollow fiber membrane offers advantages such as low shear forces and minimal cell damage, but they are prone to filament breakage, limiting their industrial scalability due to restricted membrane materials and filtration pores types. The plate membrane, on the other hand, boasts a wider variety of membrane materials and filtration aperture types, making it relatively easier to scale up industrially. However, the structural characteristics of the filtration membranes used in plate membrane technology and the filtration screens contribute to higher shear forces, potentially damaging sensitive substances in the liquid, thus impacting filtration efficiency and effectiveness. For example, sensitive substances like cells in the liquid may easily lose their structural integrity during filtration, thereby affecting cell viability.

In order to solve the above problem, the present disclosure provides an apparatus for filtration with the improved filtration efficiency and filtration effect, which significantly reduces damage to substances that are sensitive to shear forces in the liquid. At the same time, the apparatus for filtration in the present disclosure also possesses the advantages of both the hollow fiber membrane and the flat plate membrane.

### SUMMARY

One of the embodiments of the present disclosure provides an apparatus for filtration. The apparatus may include at least one filtration layer and at least one flow-through layer disposed along a filtration direction of the filtration layer. One of the at least one flow-through layer may include at least one first support member and at least one first flow channel, the at least one first flow channel may be configured for a liquid to flow, and the at least one first support member may define the at least one first flow channel.

In some embodiments, a retention end of the apparatus for filtration may be in communication with the at least one flow-through layer, a retention liquid in the at least one flow-through layer may be discharged through the retention end of the apparatus for filtration, and an inlet end of the apparatus for filtration may be in flow communication with the at least one flow-through layer.

In some embodiments, the at least one first support member may include a plurality of first support members spaced apart, and one of the at least one first flow channel may be arranged between two adjacent first supporting members among the plurality of first support members. In some embodiments, the at least one first support member may be in a wavy plate-like structure, and one or more first grooves may be disposed on both sides of the first supporting member along a thickness direction, and the one or more first grooves may define the at least one first flow channel.

In some embodiments, the at least one first flow channel may include a plurality of first flow channels, two adjacent first flow channels of the plurality of first flow channels may be separated by one of the at least one first support member, the first support member may be provided with a first communication pore, and the two adjacent first flow channels may be in flow communication through the first communication pore.

In some embodiments, the at least one filtration layer may include a filtration screen and one or more filtration membranes, one of the one or more filtration membranes may include at least one of a hollow fiber membrane, a plate membrane, or a rolled membrane, and the filtration screen may support the one or more filtration membranes.

In some embodiments, the at least one flow-through layer may include a plurality of flow-through layers, wherein one of the at least one filtration layer may be disposed on each of both sides along a thickness direction of one of the plurality of flow-through layers. In some embodiments, the at least one filtration layer may include a plurality of filtration layers, wherein one of the at least one flow-through layer may be disposed on each of both sides of one of the plurality of filtration layers along a filtration direction of the one of the at least one filtration layer.

In some embodiments, the apparatus for filtration may be a columnar structure. The apparatus for filtration may include a filtrate discharge pipeline, the at least one filtration layer and the at least one flow-through layer may be spirally encircled along a circumferential direction of the filtrate discharge pipeline and may be alternately disposed along a radial direction of the filtrate discharge pipeline. The filtrate discharge pipeline may be provided with a collection pore passing through a side wall of the filtrate discharge pipeline. Ends of the at least one flow-through layer and the at least one filtration layer away from the filtrate discharge pipeline along a spiral direction may be both closed, an end of each of the at least one flow-through layer close to the filtrate discharge pipeline along the spiral direction may be connected to the side wall of the filtrate discharge pipeline, and an end of each of the at least one filtration layer close to the filtrate discharge pipeline may be in flow communication with the filtrate discharge pipeline through the collection pore.

In some embodiments, the apparatus for filtration may be a columnar structure. The apparatus for filtration may include a filtrate discharge pipeline, the filtrate discharge pipeline may be provided with a collection pore passing through a side wall of the filtrate discharge pipeline; a plurality of filtration groups may be provided apart along a circumferential direction of the filtrate discharge pipeline, and the plurality of filtration groups may be spirally encircled along the circumferential direction of the filtration discharge pipeline. Each filtration group of the plurality of filtration groups may include one of the at least one filtration layer and one of the at least one flow-through layer connected to the at least one filtration layer. For each filtration group, ends of the flow-through layer and the filtration layer away from the filtrate discharge pipeline along a spiral direction may be closed, an end of the flow-through layer close to the filtrate discharge pipeline along the spiral direction may be connected to the side wall of the filtrate discharge pipeline, and an end of the filtration layer close to the filtrate discharge pipeline may be in flow communication with the filtrate discharge pipeline through the collection pore.

In some embodiments, the apparatus for filtration may be a columnar structure, each of the at least one filtration layer and the at least one flow-through layer of the apparatus for filtration may be an annular structure, and the at least one filtration layer and the at least one flow-through layer may be coaxially disposed.

In some embodiments, the apparatus for filtration may further include at least one permeable layer disposed along the filtration direction of the at least one filtration layer. One of the at least one permeable layer may be provided with at least one second support member and at least one second flow channel, and the at least one second support member may define the at least one second flow channel.

In some embodiments, the at least one second support member may include a plurality of second support members spaced apart, and one of the at least one second flow channel may be defined between two adjacent second supporting members among the plurality of second support members. Each of the second support members may be provided with at least one second communication pore, and the at least one second communication pore may be in flow communication with two adjacent second flow channels.

In some embodiments, the apparatus for filtration may further include at least one liquid-dispensing component, wherein one of the at least one liquid-dispensing component may be disposed at an inlet end of the apparatus for filtration or a retention end of the apparatus for filtration.

In some embodiments, the liquid-dispensing component may include a liquid main pipe, a plurality of liquid diverters, and a housing. The plurality of liquid diverters may be spaced apart in the housing along a height direction of the housing, and along the height direction of the housing, a cross-sectional area of a side of each of the plurality of liquid diverters away from the liquid main pipe may be larger than a cross-sectional area of a side of each of the plurality of liquid diverters close to the liquid main pipe. An external pipeline may be in flow communication with an interior of the housing through the liquid main pipe.

In some embodiments, the liquid-dispensing component may further include a first liquid-drainage. The first liquid-drainage may be disposed on the side of the plurality of liquid diverters close to the liquid main pipe, and along the height direction of the housing, a cross-sectional area of a side of the first liquid-drainage away from the liquid main pipe may be larger than a cross-sectional area of a side of the first liquid-drainage close to the liquid main pipe.

In some embodiments, one of the liquid diverters may include a plurality of diverting bars, along the height direction of the housing, and a cross-sectional area of a side of each of the plurality of diverting bars away from the liquid main pipe may be larger than a cross-sectional area of a side of each of the plurality of diverting bars close to the liquid main pipe. The plurality of diverting bars may be spaced apart along the height direction of the housing.

In some embodiments, the plurality of liquid diverters may be a plurality of liquid-diverting rings, the plurality of liquid-diverting rings may be coaxially disposed, and an angle between the axial direction of the liquid-diverting ring and the height direction of the housing may be less than 90°.

In some embodiments, the liquid-dispensing component may include a liquid main pipe and at least one liquid branch pipe. One of the at least one liquid branch pipe may include a first opening and a plurality of second openings. An end of the liquid main pipe may be connected to the first opening of the liquid branch pipe, the other end of the liquid main pipe may be connected to an external pipeline, and the plurality of second openings of the liquid branch pipe may correspond to an end surface of at least one of the inlet end of the apparatus for filtration or the retention end of the apparatus for filtration.

In some embodiments, the liquid-dispensing component may include a liquid main pipe, a drainage pipe, a port, a plurality of liquid-diverting baffles. The port may be disposed at a side portion of the drainage pipe, an end of the drainage pipe may be connected to the liquid main pipe, the plurality of liquid-diverting baffles may be disposed inside the drainage pipe and spaced apart along a direction from close to the port to away from the port, and a length of each of the plurality of liquid-diverting baffles along an extension direction of the drainage pipe may increase along the direction from close to the port to away from the port; and the plurality of liquid-diverting baffles may define a plurality of second drainage channels inside the drainage pipe. Each of the plurality of second drainage channels may be in flow communication with the liquid main pipe and the port, and the port may correspond to at least one of the inlet end of the apparatus for filtration or the retention end of the apparatus for filtration.

One of the embodiments of the present disclosure provides a method for filtration. The method may include: feeding a liquid through an inlet end of an apparatus for filtration; and collecting a retention liquid discharged from a retention end of the apparatus for filtration.

In some embodiments, the feeding a liquid through an inlet end of an apparatus for filtration may include: disposing a liquid-dispensing component at the inlet end of the apparatus for filtration; transporting the liquid to the inlet end of the apparatus for filtration through the liquid-dispensing component; and/or the collecting a retention liquid discharged from a retention end of the apparatus for filtration includes: disposing the liquid-dispensing component at the retention end of the apparatus for filtration; and collecting the retention liquid discharged from the retention end of the apparatus for filtration through the liquid-dispensing component.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure:

FIG. 1 is a schematic diagram illustrating a cross-section of an apparatus for filtration provided with a permeation layer according to some embodiments of the present disclosure;

FIG. 2 is a schematic diagram illustrating a cross-section of an apparatus for filtration provided with a permeation layer according to some other embodiments of the present disclosure;

FIG. 3 is a schematic diagram illustrating a cross-section of an apparatus for filtration provided with a permeation layer according to some other embodiments of the present disclosure;

FIG. 4 is a schematic diagram illustrating a cross-section of a first support member according to some embodiments of the present disclosure;

FIG. 5 is a schematic diagram illustrating an exemplary connection structure between a first support member and a housing according to some embodiments of the present disclosure;

FIG. 6 is a schematic diagram illustrating a cross-section of the connection structure shown in FIG. 5;

FIG. 7 is a schematic diagram illustrating an exemplary connection structure between a second support member and a housing according to some embodiments of the present disclosure;

FIG. 8 is a schematic diagram illustrating a cross-section of the connection structure shown in FIG. 7;

FIG. 9 is a schematic diagram illustrating an exemplary connection structure between a filtration screen and a housing according to some embodiments of the present disclosure;

FIG. 10 is a schematic diagram illustrating a cross-section of the connection structure shown in FIG. 9;

FIG. 11 is a schematic diagram illustrating a cross-section of a mechanism for filtration not provided with a permeation layer according to some embodiments of the present disclosure;

FIG. 12 is a schematic diagram illustrating a cross-section of a mechanism for filtration not provided with a permeation layer according to some other embodiments of the present disclosure;

FIG. 13 is a schematic diagram illustrating a cross-section of a mechanism for filtration not provided with a permeation layer according to some other embodiments of the present disclosure;

FIG. 14 is a schematic diagram illustrating a cross-section of an apparatus for filtration according to some other embodiments of the present disclosure;

FIG. 15 is a schematic diagram illustrating a flowing direction of a liquid in at least one flow-through layer of the apparatus for filtration in FIG. 14;

FIG. 16 is a schematic diagram illustrating a flowing direction of a leachate in at least one filtration layer of the apparatus for filtration in FIG. 14;

FIG. 17 is a schematic diagram illustrating a cross-section of an apparatus for filtration according to some other embodiments of the present disclosure;

FIG. 18 is a schematic diagram illustrating a cross-section of an apparatus for filtration according to some other embodiments of the present disclosure;

FIG. 19 is a schematic diagram illustrating a structure of a liquid-dispensing component placed at a first angle according to some embodiments of the present disclosure;

FIG. 20 is a schematic diagram illustrating a structure of a liquid-dispensing component placed at a second angle according to some embodiments of the present disclosure;

FIG. 21 is a schematic diagram illustrating a structure of a liquid-dispensing component placed at a first angle according to some other embodiment of the present disclosure;

FIG. 22 is a schematic diagram illustrating a structure of a liquid-dispensing component placed at a second angle according to some other embodiment of the present disclosure;

FIG. 23 is a schematic diagram illustrating a simple structure of a liquid-dispensing component according to some other embodiments of the present disclosure; and

FIG. 24 is a schematic diagram illustrating a simple structure when a liquid-dispensing component cooperates with an inlet end of an apparatus for filtration according to some other embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

As shown in this specification and the claims, unless the context clearly suggests an exception, the words “a”, “an”, and/or “the” does not refer specifically to the singular, but may also include the plural. Generally, the terms “including” and “comprising” suggest only the inclusion of clearly identified steps and elements that do not constitute an exclusive list, and the method or apparatus may also include other steps or elements.

The present disclosure provides an apparatus for filtration. The apparatus may include at least one filtration layer and at least one flow-through layer disposed along a filtration direction of the filtration layer. One of the at least one flow-through layer may include at least one first support member and at least one first flow channel, and the at least one first support member may define the at least one first flow channel. When a liquid is injected into the apparatus for filtration, the liquid may enter into the filtration layer via the first flow channel, and then may be filtered by a filtration membrane of the filtration layer. When the filtration membrane filters the liquid, the first support member of the flow-through layer may support the filtration membrane, and establish one or more channels to guide the liquid to flow over a surface of the filtration membrane. By utilizing the rigidity of the first support member, the first flow channel and the filter membrane may not be significantly deformed during an entire filtration process, so that the path of the first flow channel can be well maintained, thereby making the resistance and disturbance encountered by the liquid during the flow process smaller, and being closer to a laminar flow state, greatly reducing a shear force on the liquid and significantly reducing the damage to the active substances in the liquid. For example, the damage to cells in the liquid may be reduced, thus improving cell activity. In some embodiments, an extension direction of the first flow channel may be parallel to the surface of the filtration layer, so that when the liquid flows into the filtration layer from the first flow channel, a tangential flow can effectively avoid clogging of the filtration layer (e.g., the filtration membrane of the filtration layer). On the other hand, the first flow channel ensures that the liquid is subjected to a very small shear force, which greatly reduces the damage to sensitive substances (e.g., cells, etc.), greatly enhances the filtration efficiency and improves the filtration effect.

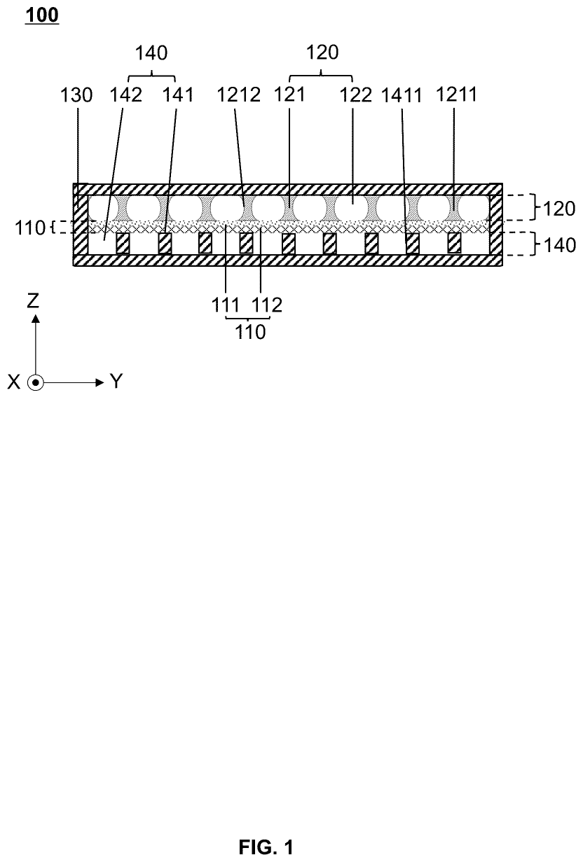

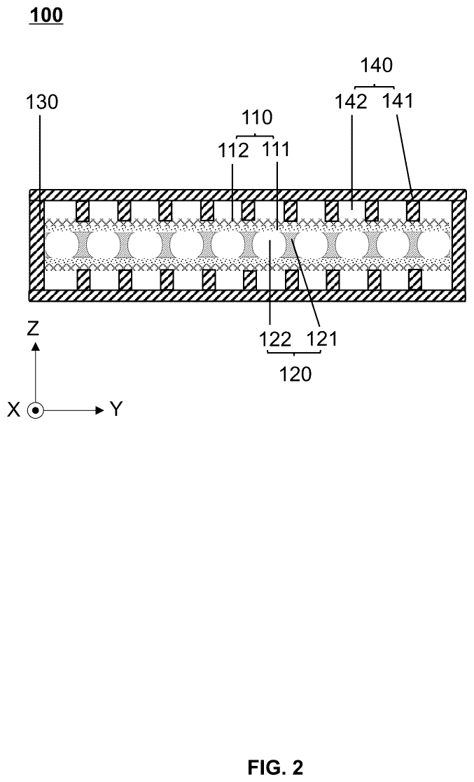

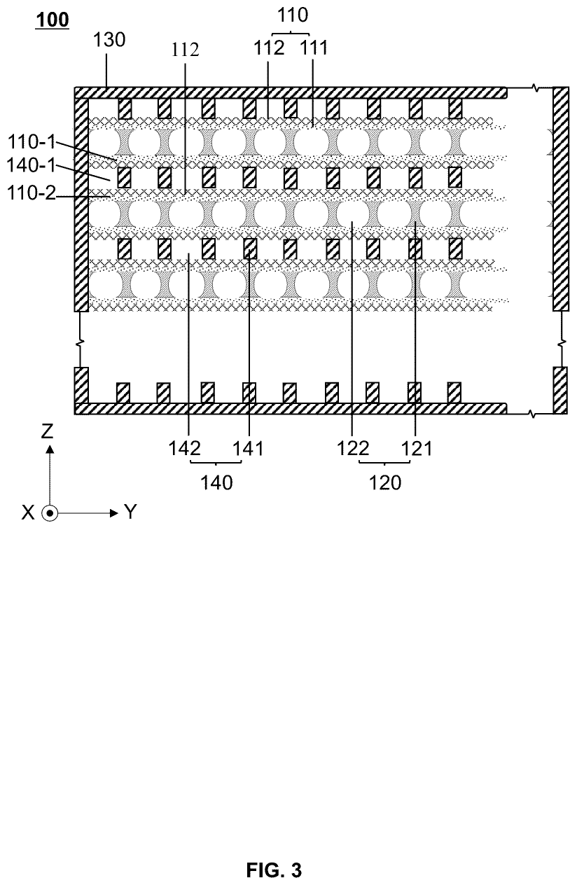

FIG. 1 is a schematic diagram illustrating a cross-section of an apparatus for filtration provided with a permeation layer according to some embodiments of the present disclosure; FIG. 2 is a schematic diagram illustrating a cross-section of an apparatus for filtration provided with a permeation layer according to some other embodiments of the present disclosure; and FIG. 3 is a schematic diagram illustrating a cross-section of an apparatus for filtration provided with a permeation layer according to some other embodiments of the present disclosure. In some embodiments, as shown in FIGS. 1-3, an apparatus 100 for filtration may include at least one filtration layer 110 and at least one flow-through layer 120 disposed along a filtration direction of the filtration layer 110. One of the at least one flow-through layer 120 may include at least one first support member 121 and at least one first flow channel 122. The at least one first flow channel 122 may be configured for a liquid to flow, and the at least one first support member 121 may define the at least one first flow channel 122.

The filtration direction of the filtration layer 110 refers to a linear direction in which a permeation direction of the liquid along the filtration layer 110 is located, e.g., a linear direction in which a permeation direction of the liquid when entering into the filtration layer 110 or a permeation direction of a liquid that has been filtered is located. The filtration direction of the filtration layer 110 may be represented by the Z-axis in FIG. 1. The at least one first support member 121 may define the at least one first flow channel 122, which means that the at least one first flow channel 122 is formed by the at least one first support member 121, or is mainly formed by the at least one first support member 121 together with other structures (e.g., the housing of the apparatus 100 for filtration).

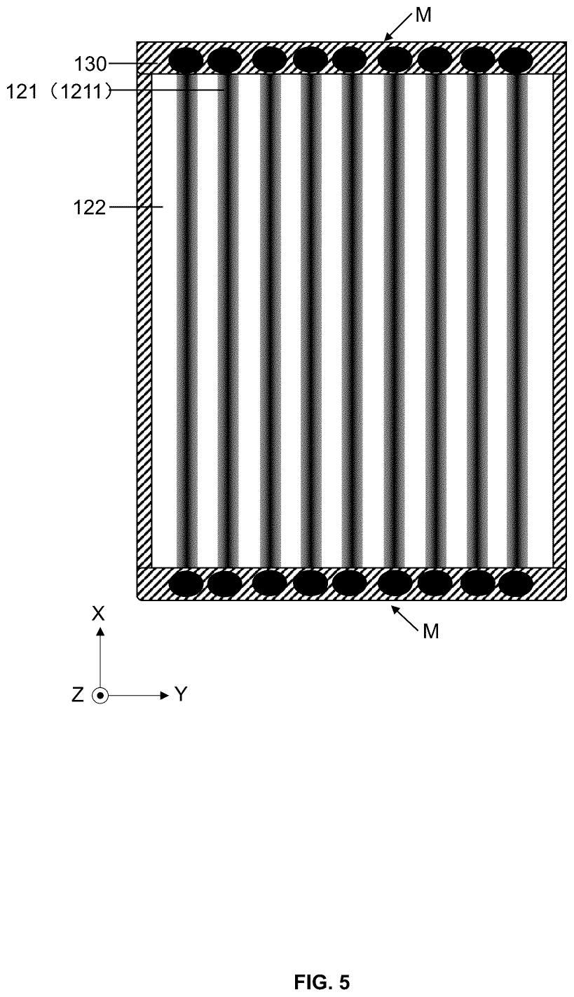

In some embodiments, the apparatus 100 for filtration may further include a housing 130. The at least one flow-through layer 120 and the at least one filtration layer 110 may be disposed within the housing 130. In some embodiments, an inlet end of the apparatus 100 for filtration may be in flow communication with the at least one flow-through layer 120. In some embodiments, the inlet end of the apparatus 100 for filtration may be provided on the housing 130. In this embodiment, since the inlet end of the apparatus 100 for filtration is in flow communication with the at least one flow-through layer 120, the liquid may be fed through the inlet end of the apparatus 100 for filtration into each of the at least one first flow channel 122 of the flow-through layer 120, and flow along the extension direction of the at least one first flow channel 122. Since the at least one flow-through layer 120 is disposed along the filtration direction of the at least one filtration layer 110, the liquid, when flowing along the at least one first flow channel 122, may begin to be filtered along a contact surface of each of the at least one first flow channel 122 and one of the at least one filtration layer 110 adjacent to the each of the at least one first flow channel 122. In addition, the at least one first support member 121 may support the filtration layer 110, creating one or more channels that guide the liquid flowing across a surface of the filtration layer 110. By utilizing the rigidity of the at least one first support member 121, the at least one first flow channel 122 and the filtration layer 110 will not be significantly deformed throughout a filtration process, so that a diameter of the at least one first flow channel 122 can be well maintained, thereby making the liquid in a flowing process subject to less resistance and perturbation and closer to a laminar flow state. Meanwhile, a shear force to the liquid can be greatly reduced, and the damage to active substances in the liquid can be significantly reduced. For example, the damage to the cells in the liquid can be reduced, thereby improving cell activity. In some embodiments, a retention end (not shown in the figures) of the apparatus 100 for filtration may be in flow communication with the at least one flow-through layer 120, and a retention liquid in the flow-through layer 120 may be discharged via the retention end. The retention liquid refers to a portion of the liquid that is retained in the flow-through layer 120 after the liquid enters the flow-through layer 120. A liquid flowing from the flow-through layer 120 into the filtration layer 110 is the leachate. In some embodiments, the inlet end of the apparatus 100 for filtration may be the inlet of the flow-through layer 120, and the inlet end of the apparatus 100 for filtration may be represented by M in FIG. 5. In some embodiments, the retention end of the apparatus 100 for filtration may be the outlet of the flow-through layer 120, and the retention end of the apparatus 100 for filtration may be represented by N in FIG. 5. In other embodiments, the inlet end and the retention end of the apparatus 100 for filtration may be exchanged, that is, N may represent the inlet end of the apparatus 100 for filtration and M may represent the retention end of the apparatus 100 for filtration.

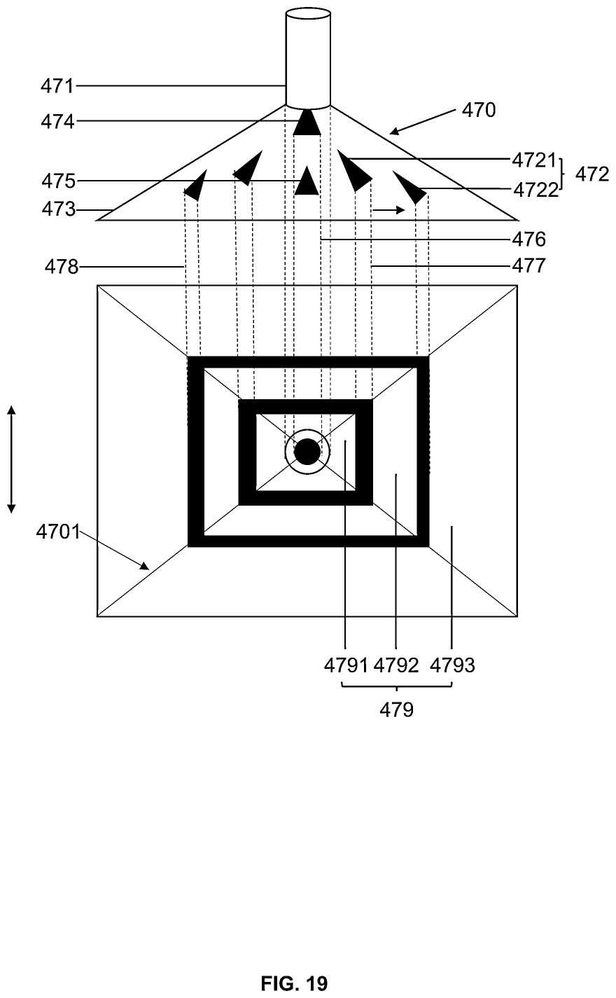

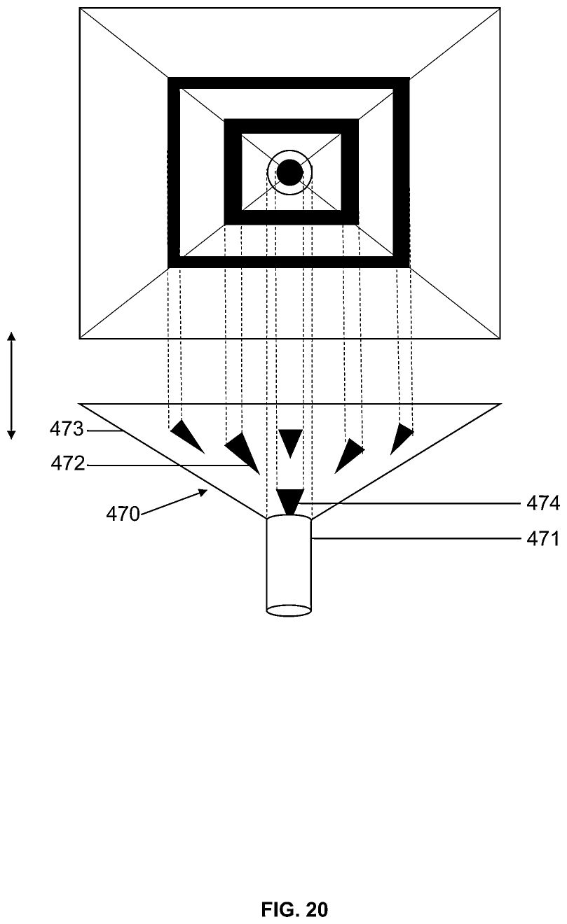

In some embodiments, the housing 130 may be used to support other components of the apparatus 100 for filtration. For example, the housing 130 may be used to secure the at least one first support member 121 of the flow-through layer 120. As another example, the housing 130 may be used to secure the filtration layer 110 (e.g., a filtration screen 112 of the filtration layer 110). As a further example, the housing 130 may be used to secure a liquid-dispensing component (e.g., a liquid-dispensing component 470 in FIG. 19 and FIG. 20). In some embodiments, a material used to produce the housing 130 may include resins, polyoxymethylene (POM), or the like, or a combination thereof.

In some embodiments, the count of the at least one first flow channel 122 may be equal to 1, i.e., the at least one first flow channel 122 may include one first flow channel. In some embodiments, the count of the at least one first flow channel 122 may exceed 1, i.e., the at least one first flow channel 122 may include a plurality of first flow channels spaced apart. In some embodiments, the plurality of first flow channels 122 may be disposed spaced apart in parallel, and a surface where the plurality of first flow channels 122 are disposed may be parallel to a surface of the filtration layer 110. In other words, the plurality of first flow channels 122 may be perpendicular to the surface of the filtration layer 110. A distribution direction of the plurality of first flow channels 122 (i.e., a direction in which the plurality of first flow channels 122 are disposed spaced apart) may be represented by a Y-axis. In some embodiments, two adjacent first flow channels 122 may be spaced by one first support member 121. In some embodiments, since two adjacent first flow channels 122 are spaced by one first support member 121, each first flow channel 122 is relatively independent, and each first flow channel 122 may be independently configured for the liquid to flow, and the liquid in each first flow channel 122 may not affect each other, making the liquid in each first flow channel 122 more uniform, which is more conducive to a tangential flow of the liquid along the surface of the filtration layer 110, thereby delaying accumulation and concentration polarization of substances retained by the filtration layer 110 on the surface of the filtration layer 110, avoiding premature clogging of the filtration layer 110, and improving the filtration effect.

In some embodiments, the extension direction of the at least one first flow channel 122 may be parallel to the surface of the filtration layer 110, so that when the liquid flows into the filtration layer 110 from the at least one first flow channel 122, on the one hand, the tangential flow can effectively avoid the clogging of the filtration layer 110, and on the other hand, the at least one first flow channel 122 ensures that the liquid is subjected to a very small shear force, which greatly reduces the damage to sensitive substances (e.g., cells), thereby enhancing the filtration efficiency and significantly improving the filtration effect.

In some embodiments, each of the at least one first support member 121 may be provided with a first communication pore (not shown in the figures), and when there are a plurality of first flow channels 122, the first communication pore of the at least one first support member 121 may connect two adjacent first flow channels 122 so that liquids in the adjacent first flow channels 122 may flow to each other and be diffused.

In some embodiments, the count of the at least one flow-through layer 120 may be equal to 1, and disposed along the filtration direction of the filtration layer 110. The extension direction of the flow-through layer 120 may be perpendicular to the filtration direction of the filtration layer 110. For example, in some embodiments shown in FIG. 1, there may include one filtration layer 110 and one flow-through layer 120, and the flow-through layer 120 may be disposed on one side of the filtration layer 110 along the filtration direction of the filtration layer 110. As another example, in some embodiments shown in FIG. 2, one filtration layer 110 may be disposed on each of two sides of the flow-through layer 120 along a thickness direction of the flow-through layer 120, i.e., for each filtration layer 110, there may be one flow-through layer 120 disposed along the filtration direction of the filtration layer 120. In some embodiments, a plurality of flow-through layers 120 may be disposed along the filtration direction of the filtration layer 110. Merely by way of example, the plurality of flow-through layers 120 may be disposed on two sides of the filtration layer 110 along the filtration direction of the filtration layer 110. For example, the embodiment illustrated in FIG. 1 may be changed by adding the flow-through layer 120 between the filtration layer 110 and a permeation layer 140.

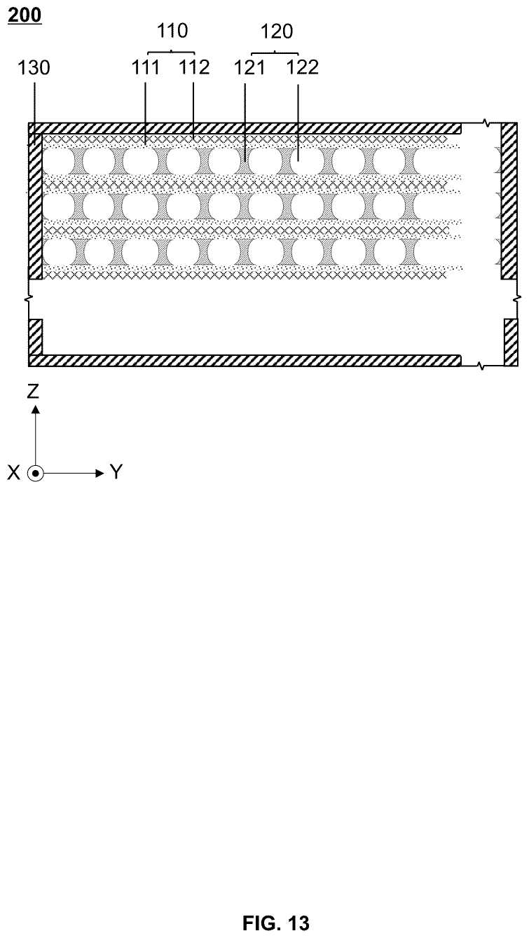

In some embodiments, there may be a plurality of filtration layers 110, and the plurality of filtration layers 110 may be disposed on two sides of the flow-through layer 120 along the thickness direction of the flow-through layer 120. Merely by way of example, as shown in FIG. 2, there are two filtration layers 110 and one flow-through layer 120, and one of the two filtration layers 110 is disposed on one side of the flow-through layer 120 along the thickness direction of the flow-through layer 120. Since there is one filtration layer 110 disposed on each side of the flow-through layer 120 along the thickness direction of the flow-through layer 120, a liquid in each first flow channel 122 may touch contact surfaces of two adjacent filtration layers 110 and be filtered, respectively, and the flow-through layer 120 may support the two filtration layers 110 on both sides at the same time, which can improve the filtration efficiency while ensuring the structural rigidity of the filtration layers 110 on two sides, further ensures that the at least one first flow channel 122 and the filtration layers 110 may not be significantly deformed during an entire filtration process. In some embodiments, there may be a plurality of filtration layers 110, and at least one of the plurality of filtration layers 110 may be provided with the flow-through layers 120 on two sides along the filtration direction of the filtration layer 110. For example, in the embodiment shown in FIG. 13, one of the filtration layers 110 is provided with the flow-through layers 120 disposed on two sides along the filtration direction of the at least one filtration layer 110.

In some embodiments, there may be a plurality of flow-through layers 120, and the filtration layers 110 may be disposed on two sides of at least one of the plurality of flow-through layers 120 along the thickness direction of the flow-through layer 120. Merely by way of example, as shown in FIG. 3, there are a plurality of filtration layers 110 and a plurality of flow-through layers 120, the plurality of flow-through layers 120 are disposed at an interval along the filtration direction of the filtration layer 110, and at least one of the plurality of flow-through layers 120 is provided with the filtration layers 110 on two sides along the thickness direction of the flow-through layer 120. As another example, as illustrated in FIG. 13, there are a plurality of filtration layers 110 and a plurality of flow-through layers 120, the filtration layers 110 are disposed on two sides of each flow-through layer 120 shown in FIG. 13 along the thickness direction of the flow-through layer 120, and one of the plurality of filtration layers 110 is provided with the flow-through layers 120 on two sides along the filtration direction of the at least one filtration layer 110. By providing the plurality of flow-through layers 120, the count of the at least one first flow channel 122 may be enlarged, thus increasing a volume of a liquid accommodated by the apparatus 100 for filtration and increasing a filtration flux of the apparatus 100 for filtration.

In some embodiments, each of the at least one filtration layer 110 may include one or more filtration membranes 111, and the filtration membranes 111 may be used to filter the liquid. For example, in the embodiment shown in FIG. 1, the filtration layer 110 may include one filtration membrane 111. As another example, the filtration layer 110 may include two filtration membranes 111. In some embodiments, the extension direction of the at least one first flow channel 122 parallel to the surface of the filtration layer 110 refers to that the extension direction of the at least one first flow channel 122 is parallel to a surface of the filtration membrane 111.

In some embodiments, the filtration membrane 111 may be configured to retain and separate large molecules from small molecules or large particles from small particles. In some embodiments, the filtration membrane 111 may allow only specific substances in the liquid to pass through and retain other substances. In some embodiments, the filtration membrane 111 may be provided with filtration pores having a specific aperture, so that when the liquid touches the filtration membrane 111, particulate matter, molecules (e.g., proteins), or tissues that are larger than the aperture of the filtration pores may be retained by the filtration membrane 111 and may not be able to pass through the filtration membrane 111, and particulate matter, molecules, or tissues that are smaller than the aperture of the filtration pores may pass through the filtration membrane 111, thereby separating the particulate matter, molecules, or tissues that are smaller than the aperture of the filtration pores from the particulate matter, molecules (e.g., proteins), or tissues that are larger than the aperture of the filtration pores. Particulate matter, molecules, or tissues that are unable to pass through the filtration membrane 111 may be retained in the at least one first flow channel 122 when the filtration membrane 111 is connected to the flow-through layer 120. Instead, particulate matter, molecules, or tissue that passes through the filtration membrane 111 may flow to other regions (e.g., the permeation layer 140).

In some embodiments, if the flow-through layer 120 is not disposed, the liquid may directly touch the filtration membrane 111 and be filtered, and substances in the liquid that are smaller than the aperture of the filtration pores of the filtration membrane 111 may typically flow in a direction perpendicular to the surface of the filtration membrane 111, that is, filtered along a tangential flow. When the liquid flows tangentially, it is necessary to apply a certain pressure to the liquid to push the liquid to pass through the filtration pores of the filtration membrane 111. When a driving force is too small to push the liquid to pass through the filtration pores of the filtration membrane 111, a transmembrane pressure (i.e., a pressure that drives the liquid to pass through the filtration membrane 111) may be insufficient and a filtration efficiency may be reduced. When the driving force is too large, the liquid may squeeze the filtration membrane 111, thereby causing the filtration membrane 111 to deform in a way that affects a shape of a flow channel of the liquid, thereby affecting a shear force to the liquid, the filtration effect, and the filtration efficiency. Additionally, since the extension direction of the at least one first flow channel 122 is parallel to the surface of the filtration membrane 111, when the liquid flows in the at least one first flow channel 122, it is equivalent to flowing along the surface of the filtration membrane 111, which not only avoids the clogging of the filtration membrane 111 due to the tangential flow of the liquid, but also allows the liquid to fully touch the surface of the filtration membrane 111, increasing a contact area between the liquid and the surface of the filtration membrane 111, greatly improving the filtration efficiency, and significantly improving the filtration effect.

In some embodiments, the filtration membrane 111 may include of a hollow fiber membrane, a tubular membrane, a ceramic membrane, a polymer membrane, or the like, or a combination thereof. In some embodiments, the filtration membrane 111 may be a flat-plate membrane, and a hollow flat-plate membrane formed by the flat-plate membrane combined with the at least one first support member 121 not only has the advantages of high flux, high selectivity, and ease of cleaning, but also has an adjustable aperture and better anti-pollution performance with a certain mechanical strength and stiffness.

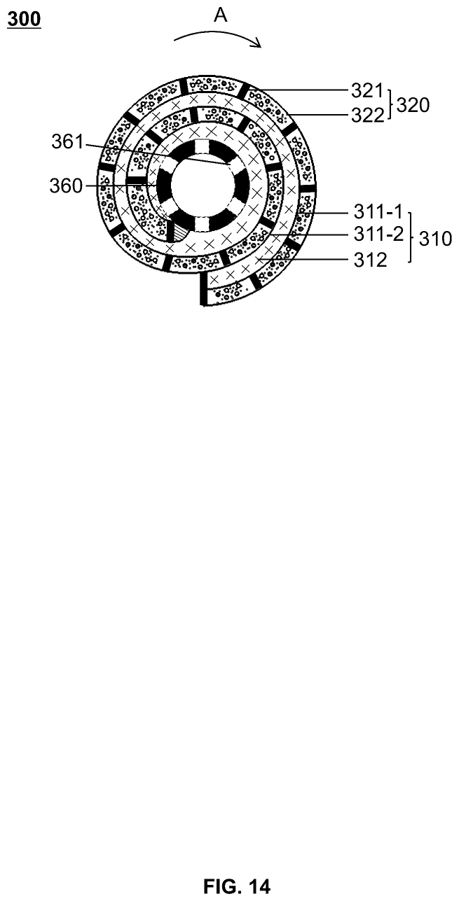

In some embodiments, a type of the filtration membrane 111 may be structurally adapted to the apparatus 100 for filtration. In some embodiments, the apparatus 100 for filtration may be a plate-like structure, and when the apparatus 100 for filtration is the plate-like structure, the filtration membrane 111 may be a hollow fiber membrane or a flat-plate membrane, so as adapt to the plate-like structure of the apparatus 100 for filtration. In some embodiments, the apparatus 100 for filtration may be a column-like structure or a structure similar to column. For example, the apparatus 100 for filtration may be a cylinder-like structure or a structure similar to cylinder, a prismatic-like structure, or a structure similar to prismatic. When the apparatus 100 for filtration is the column-like structure or the structure similar to column, the filtration membrane 111 may be a rolled membrane to fit the shape of the apparatus 100 for filtration. In some embodiments, the rolled membrane may be formed by rolling a plate membrane in other embodiments of the present disclosure. FIGS. 14-16 and related embodiments thereof provide an apparatus 300 for filtration in a form of a column-like structure, with a filtration membrane being a rolled membrane. More details about the apparatus 300 for filtration can be found in FIGS. 14-16 and embodiments thereof, which will not be repeated herein.

In some embodiments, as shown in FIG. 3, in order to increase the structural rigidity of the filtration membrane 111 and to avoid the deformation of the filtration membrane 111, the filtration layer 110 may include at least one filtration screen 112 and one or more filtration membranes 111, the filtration screen 112 may support the filtration membranes 111.

In some embodiments, the count of the at least one filtration screen 112 may be equal to 1 or exceed 1. For example, in FIG. 3, the filtration layer 110-2 includes one filtration screen 112. In some embodiments, when the flow-through layer 120 is disposed along the filtration direction of the filtration layer 110, the filtration screen 112 may be provided on a side of the filtration membrane 111 away from the flow-through layer 120, so that two sides along the filtration direction of the filtration membrane 111 are supported by the flow-through layer 120 and the filtration screen 112, respectively, thereby further improving the structural rigidity of the filtration membrane 111, reducing the degree of deformation under pressure, and ensuring that the first flow channel can be well maintained. In some embodiments, when the flow-through layers 120 are disposed on two sides along the filtration direction of the filtration layer 110, the filtration screen 112 may be disposed on a side of the filtration membrane 111 proximate to one of the flow-through layers 120.

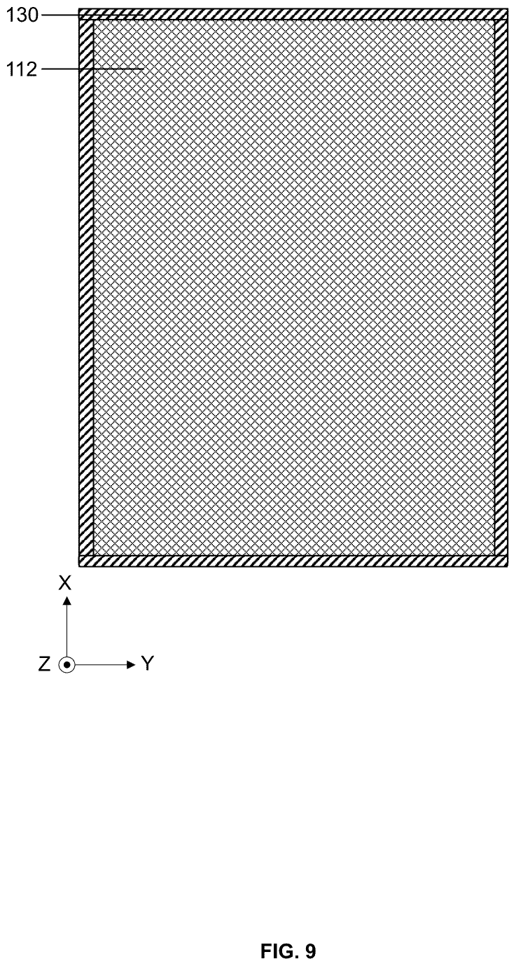

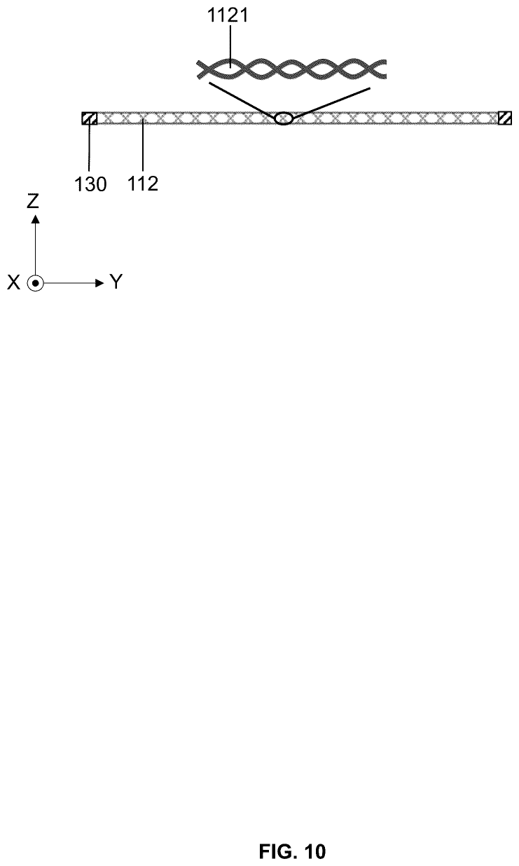

In some embodiments, the filtration screen 112 may be connected to the housing 130 at end portions, as shown in FIG. 9 and FIG. 10. In some embodiments, the filtration screen 112 may be fixedly or removably connected to the housing 130. A specific manner of the fixed connection and the detachable connection may be referred to other embodiments in the present disclosure, and will not be repeated herein. In some embodiments, a material to produce the filtration screen 112 may include nylon, polypropylene, or the like.

In some embodiments, the filtration screen 112 may further filter substances passing through the filtration membrane 111. In some embodiments, as shown in conjunction with FIG. 3, FIG. 9, and FIG. 10, the filtration screen 112 is provided with a plurality of screen pores 1121, and an aperture of the screen pore 1121 may be smaller than the aperture of the filtration pore, and the screen pore 1121 may further retain and separate molecules or particles that pass through the filtration membrane 111. A principle of retention and separation of the filtration screen 112 is the same or similar to that of the filtration membrane 111, and will not be repeated here. In some embodiments, the aperture of the screen pore 1121 may be in a range of 10 microns to 200 microns. In some embodiments, the aperture of the screen pore 1121 may be in a range of 200 micrometers to 2 millimeters. In some embodiments, the aperture of the screen pore 1121 may be in a range of 2 millimeters to 10 millimeters.

In some embodiments, in order to prevent deformation of the filtration membrane 111, it is necessary to provide a rigid support for the filtration membrane 111. The rigid support refers to a structural support that provides a higher strength, stiffness, and stability through certain materials or components, and the rigid support can withstand a relatively larger weight and pressure, allowing the entire filtration membrane 111 to remain stable and less prone to deformation. For example, a maximum deformation amount of the filtration membrane 111 may be less than 10%, 5%, 3%, etc. In some embodiments, a material used to make the at least one first support member 121 may include polyoxymethylene (POM), polypropylene, polycarbonate (PC), or the like.

In some embodiments, as shown in FIGS. 1-3, the at least one first support member 121 may include a plurality of first support members 121 spaced apart, each first support member 121 may extend along an extension direction of the at least one first flow channel 122, and one of the at least one first flow channel 122 may be disposed between two adjacent first support members 121 in the plurality of first support members 121. The extension direction of the at least one first flow channel 122 may be perpendicular to the filtration direction of the at least one first flow channel 122 and the distribution direction. The extension direction of the at least one first flow channel 122 may be represented by an X-axis. Merely by way of example, in the embodiment shown in FIG. 1, the at least one first support member 121 includes a plurality of first support members 121 (two first support members 121 located at two ends along a distribution direction of the at least one first flow channel 122 are not fully shown), the plurality of first support members 121 are disposed parallel to each other and disposed along a Y-axis direction at an interval, and the extension direction of each of the plurality of first support members 121 is parallel to the surface of the filtration layer 110, and one of the at least one first flow channel 122 is disposed between two adjacent first support members 121 in the plurality of first support members 121.

It is to be noted that a count of the at least one first support member 121 and a count of the at least one first flow channel 122 in the embodiment shown in FIG. 1 are for illustrative purposes only and not intended to limit the count of the at least one first support member 121 and the count of the at least one first flow channel 122, and the count of the at least one first support member 121 and the count of the at least one first flow channel 122 may be increased or decreased according to actual needs. For example, if there is a lot of liquid, the count of the at least one first support member 121 and the count of the at least one first flow channel 122 may be increased, and if the liquid is less, the count of the at least one first support member 121 and the count of the at least one first flow channel 122 may be decreased.

In some embodiments, two ends of each of the plurality of first support members 121 along the length direction may be connected to the housing 130, respectively, as shown in FIG. 5. In some embodiments, the two ends of each of the plurality of first support members 121 along the length direction may be removably connected to the housing 130. Exemplary removable connections may include a snap connection, a magnetic connection, or the like. In some embodiments, two ends of each of the plurality of first support members 121 along the extension direction may be fixedly connected to the housing 130 to ensure the stability of the entire apparatus 100 for filtration. Exemplary fixed connections may include gluing, hot-melt fixing, or the like.

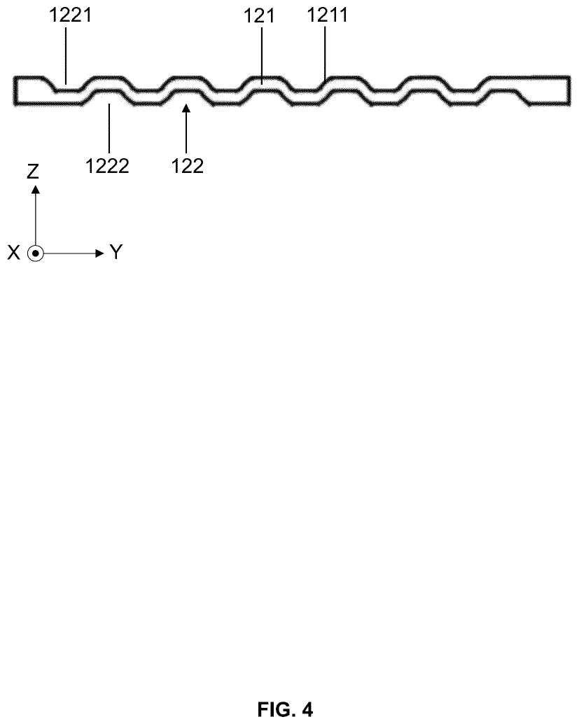

In some embodiments, as shown in FIG. 4, the first support member 121 may be in a wave-plate structure, and one or more first grooves 1211 may be disposed on both sides of the first supporting member 121 along a thickness direction, and the one or more first grooves 1211 may define the at least one first flow channel 122. The thickness direction of the at least one first support member 121 may be parallel to the filtration direction of the filtration layer 110. For illustrative purposes only, two ends of the at least one first support member 121 along the length direction may be connected to a side wall of the housing 130, a plurality of first grooves 1211 may be disposed on both sides of the first supporting member 121 in the length direction, and each of the first grooves 1211 may form one of the at least one first flow channel 122, and an extension direction of the at least one first flow channel 122 may be perpendicular to the thickness direction of the at least one first support member 121. For ease of description, the first flow channel 122 formed by the first groove 1211 disposed on an upper side along the thickness direction of the at least one first support member 121 may be referred to as a first sub-flow channel 1221, and the first flow channel 122 formed by the first groove 1211 disposed on a lower side along the thickness direction of the at least one first support member 121 may be referred to as a second sub-flow channel 1222. A plurality of first sub-flow channels 1221 may be disposed on one side along the thickness direction of the first support member 121, and extension directions of the plurality of first sub-flow channels 1221 are parallel. A plurality of second sub-flow channels 1222 are disposed on the other side of the first support member 121 and extension directions of the plurality of second sub-flow channels 1222 are parallel. In this embodiment, both the first sub-flow channels 1221 and the second sub-flow channels 1222 may be used for the liquid to flow, and each channel is used for filtration in a different direction. For example, after the liquid is injected into the first sub-flow channels 1221 and the second sub-flow channels 1222, respectively, the liquid in the first sub-flow channels 1221 may contact the filtration membrane 111 located above and be filtrated by the filtration membrane 111 located above. The liquid in the second sub-flow channels 1222 may contact the filtration membrane 111 located below and be filtrated by the filtration membrane 111 located below. In some embodiments, since the first sub-flow channels 1221 and the second sub-flow channels 1222 are disposed on the two sides along the thickness direction of the at least one first support member 121 and are divided by the at least one first support member 121, the first sub-flow channels 1221 and second sub-flow channels 1222 may be simultaneously injected with the liquid for filtration without affecting each other. In other embodiments, the wave plate-like structure is stronger and stiffer, provides stronger support for the filtration layer 110, and the filtration layer 110 is less likely to be deformed by pressure, further improving the filtration effect and speed.

In some embodiments, a surface of the at least one first support member 121 facing the filtration layer 110 is curved. The first support member 121 may include a first side wall 1212 for defining the first flow channel 122. For example, the first flow channel 122 is formed between first side walls 1212 of two adjacent first support members 121 in FIG. 1. As another example, the first flow channel 122 is formed in the first groove 1211 of the first support member 121 in FIG. 4, and an inner wall of the first groove 1211 is the first side wall 1212. A surface of the first support member 121 facing the filtration layer 110 refers to a surface of the first side wall 1212 close to the filtration layer 110. Since the surface of the at least one first support member 121 facing the filtration layer 110 is curved, a frictional resistance of molecules (e.g., cells) or particles and other substances in the liquid when passing through the surface of the at least one first support member 121 facing the filtration membrane 111 may be reduced, which can not only effectively improve a flowing speed of the molecules (e.g., cells) or particles and other substances, but also avoid the molecules (e.g., cells) or particles and other substances in the liquid from accumulating within the at least one first flow channel 122, thereby reducing the possibility of blockage in the at least one first flow channel 122 and improving the filtration efficiency and the filtration effect.

In some embodiments, the apparatus 100 for filtration may further include at least one permeation layer 140 disposed along the filtration direction of the filtration layer 110. For example, in FIG. 1, one permeation layer 140 is disposed on a side of the filtration layer 110 away from the flow-through layer 120. After the liquid is injected into the at least one first flow channel 122, the liquid may begin to be filtered along a contact surface between each first flow channel 122 with an adjacent filtration membrane 111, and when passing through the filtration membrane 111, the liquid may be filtered along a contact surface between the surface of the filtration membrane 111 and an adjacent permeation layer 140. In addition, the at least one first support member 121 of the flow-through layer 120 and a second support member 141 of the permeation layer 140 may support the filtration membrane 111 of the filtration layer 110 at the same time, thereby further improving the rigidity of the filtration membrane 111, avoiding deformation of the filtration membrane 111 due to pressure from the liquid, and improving the filtration effect and the filtration speed.

In some embodiments, the permeation layer 140 may be provided with at least one second support member 141 and at least one second flow channel 142, and the at least one second support member 141 may define the at least one second flow channel 142.

In some embodiments, the at least one second flow channel 142 includes a plurality of second flow channels 142 spaced apart, and two adjacent second flow channels 142 may be spaced by one of the at least one second support member 141. The plurality of second flow channels 142 spaced apart may be parallel to each other and a plane on which the plurality of second flow channels 142 are located is parallel to the surface of the filtration layer 110. In some embodiments, since two adjacent second flow channels 142 are spaced from each other by one of the at least one second support member 141, each second flow channel 142 is relatively independent, and the liquid in each second flow channel 142 does not affect each other, making the liquid in each second flow channel 142 more uniform and more favorable for the filtration of a high throughput liquid.

In some embodiments, there may be a plurality of second support members 141 spaced apart. Each of the second support members 141 extends along the length direction of the second flow channel 142, and the second flow channel 142 is arranged between two adjacent second support members 141 in the plurality of second support members 141. The extension direction of the second flow channel 142 may be represented by the X-axis. In some embodiments, the second support member 141 may be provided with a second communication pore (not shown in the figures), and when there are a plurality of the second flow channels 142, the second communication pore of the second support member 141 may connect two adjacent second flow channels 142 so that the liquid in adjacent second flow channels 142 may flow to each other and be diffused. In some embodiments, the second support member 141 may be a wave plate-like structure, and second grooves (not shown in the figure) are disposed on both sides of the second support member 141 in the thickness direction, and the second grooves may define the second flow channels 142. The thickness direction of the second support member 141 may be parallel to the filtration direction of the filtering layer 110. In some embodiments, the second support member 141 may be the same as or similar to the first support member 121.

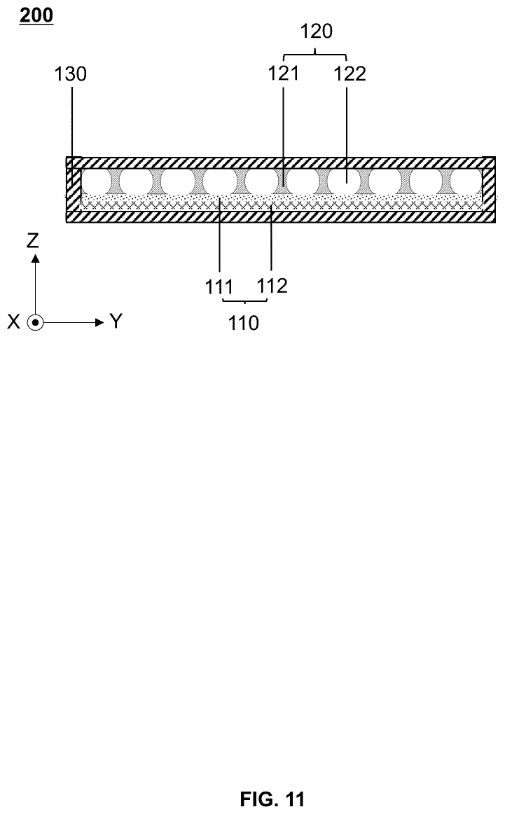

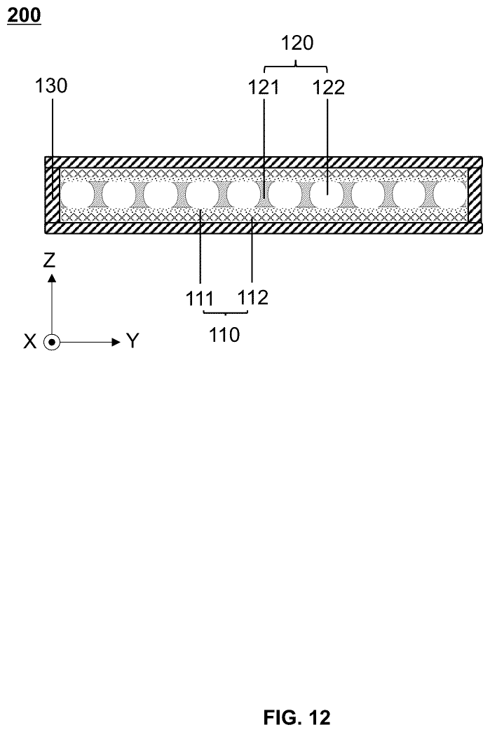

In some embodiments, the apparatus 100 for filtration may not be provided with the permeation layer 140 when complex structure matter or particles passing through the permeation layer 140 are not target biomass (i.e., biomass needed to be obtained). For example, taking FIG. 1 as an example, the target biomass is cells that are retained by the filtration layer 110, after the liquid is filtered through the flow-through layer 120, the filtration layer 110, and the permeation layer 140 in turn, a liquid that passes through the filtration layer 110 and into the permeation layer 140 may be regarded as a waste liquid, in which case there is no need to provide the permeation layer 140. FIGS. 11-13 are schematic diagrams illustrating an exemplary structure of another apparatus for filtration. Compared to the apparatus 100 for filtration shown in FIGS. 1-3, an apparatus 200 for filtration shown in FIGS. 11-13 is not provided with the permeation layer 140, and the flow-through layer 120, the filtration layer 110, and the housing 130 of the apparatus 200 for filtration may be the same as or similar to the flow-through layer 120, the filtration layer 110, and the housing 130 of the apparatus 100 for filtration. In some embodiments, complex structure matter or particles that ultimately pass through the permeation layer 140 are the target biomass, whether to provide the permeation layer 140 may be determined based on the sensitivity of the target biomass to a shear force. Merely by way of example, since an extension direction of the second flow channel 142 is perpendicular to the filtration direction of the filtration layer 110, thereby forming a tangential flow channel parallel to the filtration layer 110, complex structure matter or particulate matter entering the permeation layer 140 through the filtration layer 110 may be subjected to a larger shear force. If the complex structure matter (e.g., exosomes) or the particulate matter have a higher sensitivity to the shear force and are susceptible to be damaged by the shear force, the permeation layer 140 may be provided. If the complex structure matter or particulate matter is less sensitive to the shear force and is not susceptible to damage by the shear force, the permeation layer 140 may not be provided. The sensitivity of the complex structure matter (e.g., exosomes) or the particulate matter to shear forces is related to the shear rate tolerated by the complex structure matter (e.g., exosomes) or the particulate matter. The Shear rate refers to the shear strain generated by the fluid per unit time. For example, when the shear rate tolerated by cultured system is less than 5000 S⁻¹, it can be considered that the cultured system have a higher sensitivity to the shear force.

In some embodiments, when the second support member 141 and the second flow channel 142 (i.e., the permeation layer 140) are provided, the second support member 141 may support the filtration layer 110, and thus the filtration screen 112 may not be provided.

In some embodiments, a surface of the second support member 141 facing the filtration layer 110 is curved, so to reduce the frictional resistance of substances such as complex structure matter (e.g., cells) or particles in the liquid when passing over the surface of the second support member 141 facing the filtration membrane 111. In some embodiments, the second support member 141 may include a second side wall 1411 for defining the second flow channel 142. For example, the second flow channel 142 may be disposed between the second side walls 1411 of two adjacent second support members 141 in FIG. 1. The surface of the second support member 141 facing the filtration layer 110 refers to a surface of the second side wall 1411 close to the filtration layer 110.

In some embodiments, there may be a plurality of permeation layers 140 and a plurality of filtration layers 110, and the filtration layers 110 may be disposed on two sides of at least one permeation layer 140 along a filtration direction. In some embodiments, the filtration direction of the permeation layers 140 may be parallel to the filtration direction of the filtration layers 110. For example, in the embodiment illustrated in FIG. 3, a filtration layer 110-1 and a filtration layer 110-2 are provided on two sides along a filtration direction of a permeation layer 140-1.

In some embodiments, the apparatus for filtration may be a plate structure, for example, the apparatus for filtration may be a flat-plate structure or a curved-plate structure. Merely by way of example, in the embodiment illustrated in FIG. 1, the flow-through layer 120, the filtration layer 110, and the permeation layer 140 are in a shape of a flat plate, and thus the apparatus 100 for filtration composed of the flow-through layer 120, the filtration layer 110, and the permeation layer 140 is a plate-like structure. As another example, the flow-through layer, the filtration layer, and the permeation layer may all be in a shape of a curved plate, and thus the apparatus for filtration composed of the flow-through layer, the filtration layer, and the permeation layer is a curved-plate structure. In some embodiments, the apparatus for filtration may be a column-like structure or a structure similar to column, e.g., an elliptical column-like structure, a cylinder-like structure, a prismatic-like structure, a structure similar to elliptical column, a structure similar to cylinder, a structure similar to prismatic, etc.

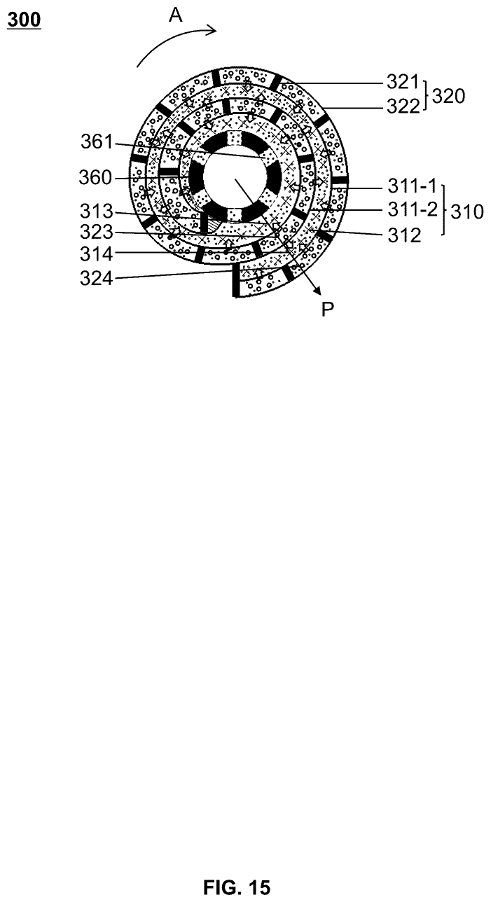

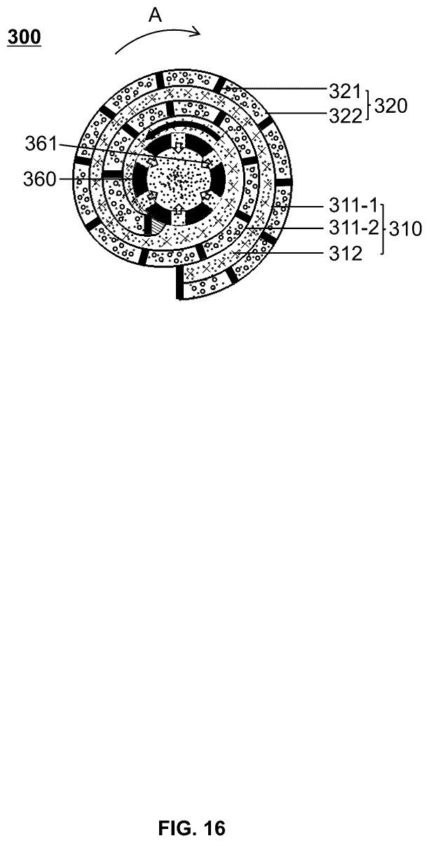

FIG. 14 is a schematic diagram illustrating a cross-section of an apparatus for filtration according to some other embodiments of the present disclosure; FIG. 15 is a schematic diagram illustrating a flowing direction of a liquid in at least one flow-through layer of the apparatus for filtration in FIG. 14; and FIG. 16 is a schematic diagram illustrating a flowing direction of a leachate in at least one filtration layer of the apparatus for filtration in FIG. 14. FIGS. 14-16 are schematic diagrams illustrating a cross-section of another apparatus for filtration. In some embodiments, the apparatus 300 for filtration may include a filtrate discharge pipeline 360. Both a filtration layer 310 and a flow-through layer 320 are spirally encircled along a circumferential direction (e.g., a direction shown by an arrow A in FIG. 14 to FIG. 16) along the filtrate discharge pipeline 360, and the filtration layer 310 and the flow-through layer 320 are provided alternately along the radial direction of the filtrate discharge pipeline 360. The filtrate discharge pipeline 360 is provided with a collection pore 361 passing through a side wall of the filtrate discharge pipeline 360. Ends of the flow-through layer 320 and the filtration layer 310 along a spiral direction that are away from the filtrate discharge pipeline 360 are closed. One end of the flow-through layer 320 along the spiral direction that is close to the filtrate discharge pipeline 360 is connected to the side wall of the filtrate discharge pipeline 360, and one end of the filtration layer 310 along the spiral direction that is close to the filtrate discharge pipeline 360 is in flow communication with the filtrate discharge pipeline 360 through the collection pore 361.

In this embodiment, the liquid may enter the flow-through layer 320 from an inlet end of the apparatus 300 for filtration. Since both the filtration layer 310 and the flow-through layer 320 are spirally encircled along a circumferential direction of the filtrate discharge pipeline 360 and alternately disposed along the radial direction of the filtrate discharge pipeline 360, the filtration layer 310 and/or the flow-through layer 320 may encircle to form a plurality of circles. Along the radial direction of the filtrate discharge pipeline 360, the filtration layer 310 and the flow-through layer 320 may have a plurality of loop layers, and the liquid in each loop layer may flow to a radially adjacent loop layer and be filtered by the loop layers (e.g., a filtration membrane 311-1 and a filtration membrane 311-2 of the filtration layer 310). For example, along a direction where an arrow P in an embodiment of FIG. 15 is located (the direction shown by the arrow P passes through a center axis of the filtrate discharge pipeline 360), the filtration layer 310 has a first filtration loop layer 313 and a second filtration loop layer 314, and the flow-through layer 320 has a first flow-through loop layer 323 and a second flow-through loop layer 324, and the first filtration loop layer 313, the first flow-through loop layer 323, the second filtration loop layer 314, and the second flow-through loop layer 324 are sequentially connected. With such setup, when the first flow-through loop layer 323 and the first filtration loop layer 313 are in flow communication, the liquid in the first flow-through loop layer 323 may flow toward the first filtration loop layer 313 (as shown by the arrows in FIG. 15) and to be filtered through the first filtration loop layer 313. When the first flow-through loop layer 323 and/or the second flow-through loop layer 324 is in flow communication with the second filtration loop layer 314, the liquid in the first flow-through loop layer 323 and/or the second flow-through loop layer 324 may flow toward the second filtration loop layer 314 (as shown by an arrow between the first flow-through loop layer 323 and the second flow-through loop layer 324 and the second filtration loop layer 314 in FIG. 15) and be filtered through the second filtration loop layer 314. In flow communication the flow-through loop layer and the filtration loop layer herein refers that substances in the liquid in the flow-through loop layer may enter the filtration loop layer under certain conditions. In some embodiments, a barrier layer may be provided between the flow-through loop layer and the filtration loop layer. For example, the barrier layer may be provided between the first flow-through loop layer 323 and the second filtration loop layer 314 to restrict the liquid in the first flow-through loop layer 323 from flowing to the second filtration loop layer 314. After the liquid is filtered through the apparatus 300 for filtration, a liquid that is retained in the flow-through layer 320 (i.e., in each flow-through loop layer) is the retention liquid, and a liquid that enters each filtration loop layer after being filtered through the filtration membrane (i.e., a liquid that flows into the filtration layer) is the leachate. Since one end of the filtration layer 310 is in communication with an interior of the filtrate discharge pipeline 360 and the other end of the filtration layer 310 is closed, and the filtration layer 310 is distributed in a spiral shape, the leachate flowing into the filtration layer 310 may flow toward a center of the apparatus 300 for filtration. For example, ends of the filtration layer 310 along a direction of the central axis of the apparatus 300 for filtration may be closed to allow the leachate in the filtration layer 310 to flow toward the filtrate discharge pipeline 360. Then, the leachate may enter the filtrate discharge pipeline 360 through the collection pore 361 of the filtrate discharge pipeline 360 (i.e., the leachate flows along a direction indicated by an arrow at the collection pore 361 in FIG. 16), and thus the leachate may be discharged from the apparatus 300 for filtration through an outlet of the filtrate discharge pipeline 360. At the same time, the retention liquid in the flow-through layer 320 may be discharged from the apparatus 300 for filtration through an outlet (i.e., the retention end of the apparatus 300 for filtration, e.g., an end surface of the flow-through layer 320) of the flow-through layer 320, thereby enabling the retention liquid and the leachate to be discharged from the apparatus 300 for filtration through different channels. In some embodiments, the flow-through loop layer is in communication with an adjacent filtration loop layer along any radial direction of the filtrate discharge pipeline 360.

In some embodiments, there may be a plurality of collection pores 361 spaced apart along the circumferential direction of the filtrate discharge pipeline 360 to improve the efficiency of the leachate in the filtration layer 310 entering the filtrate discharge pipeline 360.

In some embodiments, the filtration layer 310 may be provided on one side of the flow-through layer 320 along the thickness direction. For example, the embodiments shown in FIGS. 14-16 may be viewed as that the filtration layer 310 is provided on one side along the thickness direction of the flow-through layer 320, and when the filtration layer 310 and the flow-through layer 320 are spirally encircled and alternatively disposed along the radial direction of the filtrate discharge pipeline 360, the flow-through loop layer may be connected to different filtration loop layers. For example, along the direction where the arrow P is located in FIG. 15, the first flow-through loop layer 323 may be connected to the first filtration loop layer 313 and the second filtration loop layer 314, respectively, so that the liquid in the first flow-through loop layer 323 may be filtered through the first filtration loop layer 313 and the second filtration loop layer 314. In some embodiments, one or more filtration layers 310 may be provided on two sides of the flow-through layer 320 along the thickness direction, which will not be specifically described herein.

In some embodiments, the filtration layer 310 may include one or more filtration membranes. Merely by way of example, in the embodiments illustrated in FIG. 14 to FIG. 16, the filtration layer 310 includes a filtration membrane 311-1 and a filtration membrane 311-2. The filtration membrane 311-1 and the filtration membrane 311-2 are both spirally encircled along the circumferential direction of the filtrate discharge pipeline 360. A channel for the leachate to flow is formed between the filtration membrane 311-1 and the filtration membrane 311-2. For example, along the direction where the arrow P is located, the second filtration loop layer 314 includes the filtration membrane 311-1 and the filtration membrane 311-2, and the filtration membrane 311-2 disposed on an inner side of the second filtration loop layer 314 is connected to the first flow-through loop layer 323, and the liquid in the first flow-through loop layer 323 may be filtered through the filtration membrane 311-2. The filtration membrane 311-1 disposed on an outer side of the second filtration loop layer 314 is connected to the second flow-through loop layer 324, and the liquid in the second flow-through loop layer 324 may be filtered through the filtration membrane 311-1, so that the liquid in the flow-through layer 320 may be filtered along both directions. In another embodiment, when both the flow-through layer 320 and the filtration layer 310 form a loop layer, the filtration layer 310 may include one filtration membrane (e.g., the filtration membrane 311-1), the filtration membrane is connected to the flow-through layer 320 to filter the liquid in the flow-through layer 320.

In some embodiments, the filtration layer 310 may include a filtration screen 312 and one or more filtration membranes, and the filtration screen 312 may support the filtration membranes to form a channel for the leachate to flow. Merely by way of example, in the embodiments illustrated in FIG. 14 to FIG. 16, the filtration screen 312 is disposed between the filtration membrane 311-1 and filtration membrane 311-2 to form a channel for the filtrate to flow between the filtration membrane 311-1 and the filtration membrane 311-2. For example, along the direction where the arrow P is located in FIG. 15, the filtration membrane 311-1 is connected to the first flow-through loop layer 323, and the filtration membrane 311-2 is connected to the second flow-through loop layer 324, and the filtration screen 312 is disposed between the filtration membrane 311-1 located on the inner side of the second filtration loop layer 314 and the filtration membrane 311-2 located on the outer side of the second flow-through loop layer 314, thereby forming the channel for the leachate to flow between the filtration membrane 311-2 and the filtration membrane 311-1. The inner side refers to a side facing a center of the apparatus 300 for filtration along the direction of the arrow P, and the outer side refers to a side backing away from the center of the apparatus 300 for filtration along the direction of the arrow P. Particulate matter, molecules, or tissues in the liquid in the second flow-through loop layer 324 and the first flow-through loop layer 323 that are smaller than the aperture of the filtration pores may then enter the channel through filtration pores of the filtration membrane 311-1 and the filtration membrane 311-2, finally enter into the filtrate discharge pipeline 360 through the collection pore 361, and then be discharged from the apparatus 300 for filtration via the filtrate discharge pipeline 360.

In some embodiments, the filtration layer 310 may also include a third support member (not shown in the figures), which may replace the filtration screen 312 for supporting the filtration membranes. In some embodiments, the third support member may be the same as or similar to the first support member or the second support member in other embodiments of the present disclosure. In some embodiments, the third support member may be used in conjunction with the filtration screen 312 to increase a strength of support for the filtration membrane.

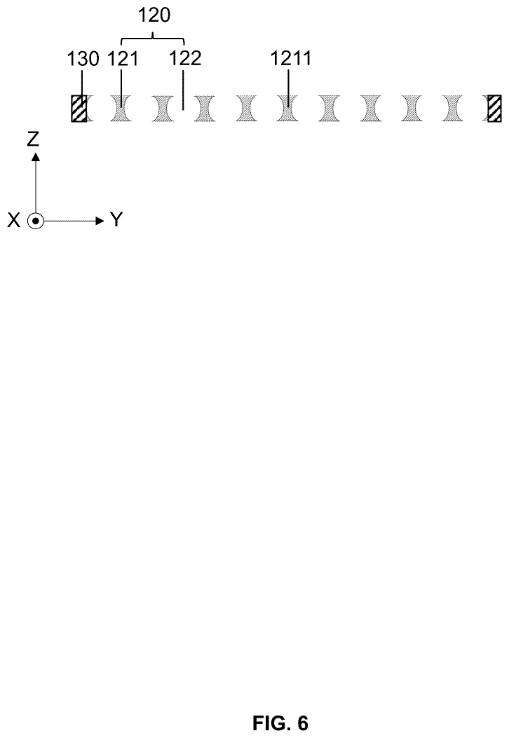

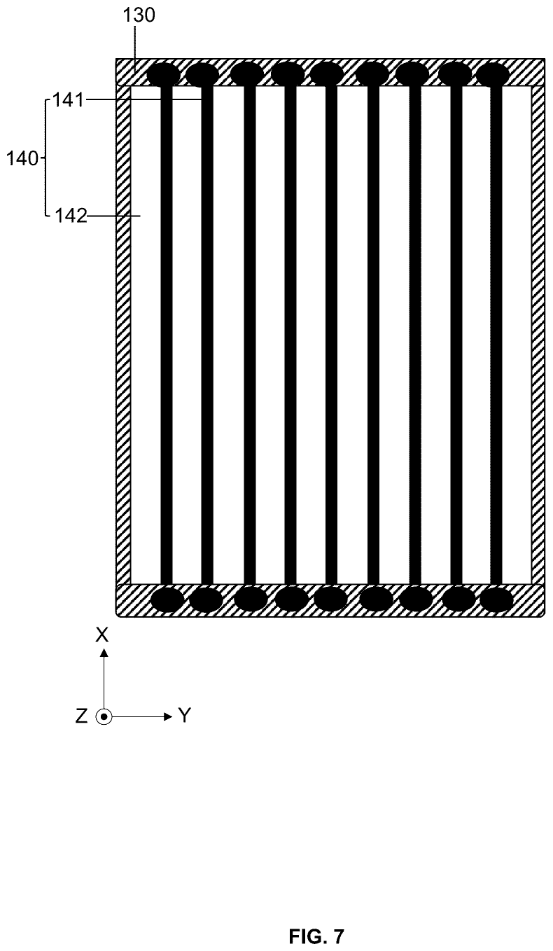

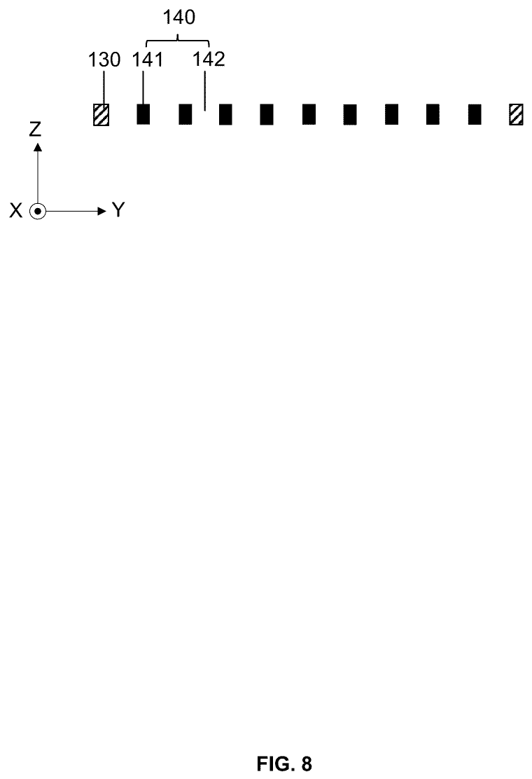

In some embodiments, the flow-through layer 320 may include at least one first support member 321 and at least one first flow channel 322, and the at least one first support member 321 and the at least one first flow channel 322 may be the same or similar to the at least one first support member 121 and the at least one first flow channel 122 in embodiments of FIG. 1 to FIG. 13, and will not be repeated herein.

In some embodiments, the apparatus 300 for filtration may also include a permeation layer (not shown in the figures). For example, on the basis of the embodiment shown in FIG. 15, the permeation layer may be added to further improve the structural rigidity of the filtration membranes, avoid the filtration membranes from being deformed by the pressure from the liquid, and improve a filtration effect and a filtration speed, on the other hand, the liquid may be further filtered to meet different filtration requirements through the permeation layer. For the convenience of description, taking the direction where the arrow P is located as a reference, the permeation layer may be disposed between the second filtration loop layer 314 and the first flow-through loop layer 323. In some embodiments, the permeation layer may be provided with at least one second support member and at least one second flow channel, the second support member may define the second flow channel, and the second flow channel and the second support member of the permeation layer are the same as or similar to the second flow channel 142 and the second support member 141 in embodiments in FIG. 1 to FIG. 3, and will not be repeated herein.

In some embodiments, the apparatus 300 for filtration may also include a housing (not shown in the figures), and the filtration layer 310 and the flow-through layer 320 are both disposed within the housing. For example, in the embodiments illustrated in FIG. 14 to FIG. 16, the housing may be disposed on the outside of the entire apparatus 300 for filtration, encasing an outermost loop layer of the flow-through layer 320, preventing the liquid in the outermost loop layer from leakage. In some embodiments, the housing may enclose ends of the flow-through layer 320 and the filtration layer 310 that are away from the filtrate discharge pipeline 360, thereby preventing the liquid in the flow-through layer and the filtrate in the filtration layer 310 from leakage.

It should be noted that the embodiments shown in FIG. 14 to FIG. 16 are for illustrative purposes only, and are not intended to limit the specific structure of the apparatus 300 for filtration, and after fully understanding the technical scheme of the apparatus 300 for filtration, the apparatus 300 for filtration in FIG. 14 to FIG. 16 may be transformed to obtain a transformed embodiment of the apparatus 300 for filtration. For example, the filtration layer 310 and the flow-through layer 320 may not be stacked along the radial direction of the filtrate discharge pipeline 360. As another example, the filtrate discharge pipeline 360 of the apparatus 300 for filtration may not be necessary, i.e., the leachate in the filtration layer 310 does not need to be collected in the filtrate discharge pipeline 360 and discharged from the apparatus 300 for filtration, but can be directly discharged from the opening of the filtration layer 310.

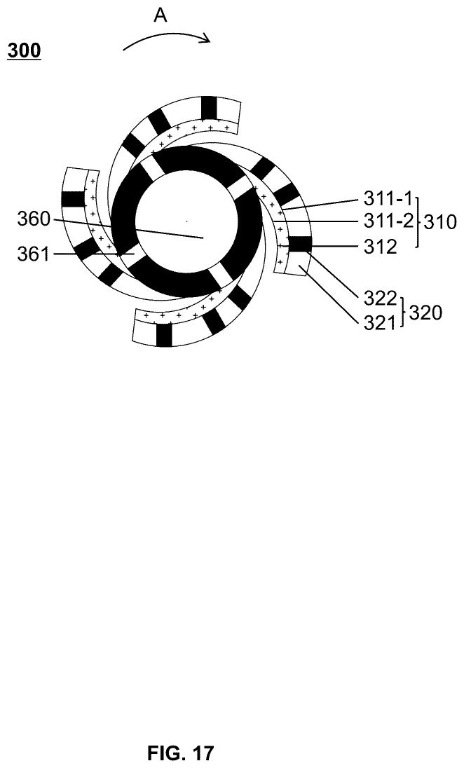

In other embodiments, the apparatus 300 for filtration may include the filtrate discharge pipeline 360 as shown in FIG. 17, the filtrate discharge pipeline 360 may be provided with at least one collection pore 361 passing through a side wall of the filtrate discharge pipeline 360. A plurality of filtration groups are disposed apart along a circumferential direction of the filtrate discharge pipeline 360, and the plurality of filtration groups are all spirally encircled along the circumferential direction of the filtrate discharge pipeline 360. Each filtration group of the plurality of filtration groups includes one of the at least one filtration layer 310 and one of the at least one flow-through layer 310 connected to the at least one filtration layer 310. For each filtration group, ends of the flow-through layer 320 and the filtration layer 310 away from the filtrate discharge pipeline 360 along a spiral direction are closed, an end of the flow-through layer 320 close to the filtrate discharge pipeline 360 along the spiral direction is connected to the side wall of the filtrate discharge pipeline 360, and an end of the filtration layer 310 close to the filtrate discharge pipeline 360 is in flow communication with the filtrate discharge pipeline 360 through the collection pore 361.

In the present embodiment, since the plurality of filtration groups are disposed at an interval along the circumferential direction of the filtrate discharge pipeline 360, each filtration group operates independently of each other. For example, in the embodiment illustrated in FIG. 17, four filtration groups are provided at an interval along the circumferential direction of the filtrate discharge pipeline 360, and each filtration group includes a flow-through layer 320 and a filtration layer 310, and the liquid in the flow-through layer 320 may flow into the filtration layer 310 connected thereto, and then enter the filtrate discharge pipeline 360 from the filtration layer 310 via the connection pore 361.

In some embodiments, the filtrate discharge pipeline 360 extends along a direction parallel to the direction of the center axis of the apparatus 300 for filtration. In some embodiments, it is not necessary for the plurality of filtration groups to be spirally encircled. For example, the plurality of filtration groups may extend along the radial direction of the filtrate discharge pipeline 360, i.e., the filtration layer 310 and the flow-through layer 320 may extend along the radial direction of the filtrate discharge pipeline 360.

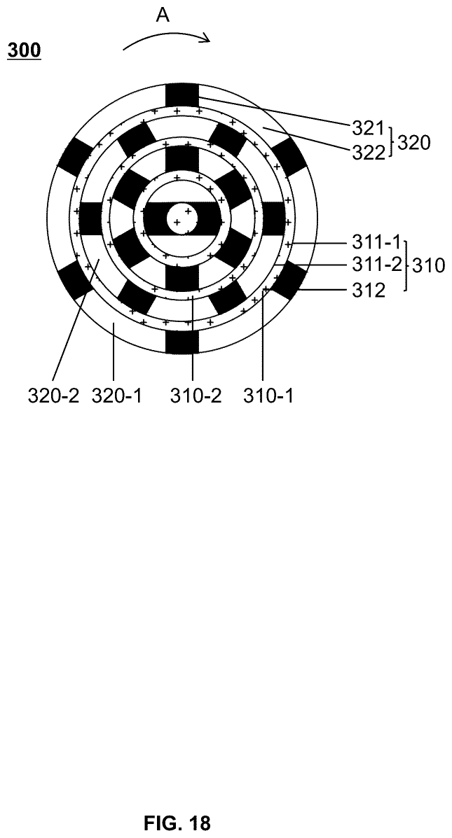

In some embodiments, as shown in FIG. 18, both the filtration layer 310 and the flow-through layer 320 of the apparatus 300 for filtration are enclosed in an annular structure (not shown in the figure), and the filtration layer 310 and the flow-through layer 320 are coaxially disposed. Openings are disposed on the filtration layer 310 and the flow-through layer 320 along a center axis direction of the annular structure. In this embodiment, the liquid may enter into the flow-through layer 320 from the inlet end of the apparatus 300 for filtration and be filtered through the filtration membrane (e.g., the filtration membrane 311-1, the filtration membrane 311-2) of the filtration layer 310, and a liquid flowing into the filtration layer 310 (i.e., the percolation liquid) may be discharged out of the apparatus 300 for filtration through the outlet of the filtration layer 310 (which is not shown in the figure), and a liquid (i.e., the retention liquid) that is retained in the flow-through layer 320 by the filtration membrane may be discharged out of the apparatus 300 for filtration through the outlet (i.e., the retention end of the apparatus 300 for filtration) of the flow-through layer 320.

In some embodiments, there may be one filtration layer 310 and one flow-through layer 320. Merely by way of example, the filtration layer 310 may be disposed on an inner side of the flow-through layer 320, i.e., the filtration layer 310 is disposed on a side of the flow-through layer 320 close to the center of the apparatus 300 for filtration, and the liquid in the flow-through layer 320 may flow to the filtration layer 310 located at the inner side of the flow-through layer and be filtered through the filtration layer 310 located at the inner side. As another example, the filtration layer 310 may be disposed on an outer side of the flow-through layer 320, i.e., the filtration layer 310 is disposed on a side of the flow-through layer 320 away from the center of the apparatus 300 for filtration, and the liquid in the flow-through layer 320 may flow to the filtration layer 310 located at the outer side of the flow-through layer 320 and be filtered through the filtration layer 310 located at the outer side.

In some embodiments, there may be a plurality of filtration layers 310 and/or a plurality of flow-through layers 320. Merely by way of example, there may be one flow-through layer 320 and two filtration layers 310, the one flow-through layer 320 is provided with a filtration layer 310-2 on the inner side of the flow-through layer 320 and a filtration layer 310-1 on the outer side of the flow-through layer 320, and the filtration layer 310-1 and filtration layer 310-2 being independent of each other. The liquid in the flow-through layer 320 may flow into the filtration layer 310-2 located at the inner side of the flow-through layer 320 and the filtration layer 310-1 located at the outer side of the flow-through layer, respectively. As another example, there may be two flow-through layers 320 and one filtration layer 310, i.e., the one filtration layer 310 is provided with a flow-through layer 320-2 on the inner side of the filtration layer 310 and a flow-through layer 320-1 on the outer side of the filtration layer 310, so that the liquid in the flow-through layer 320-2 and the flow-through layer 320-2 may flow to the filtration layer 310 and be filtered through the filtration layer 310, and a liquid that enters the filtration layer 310 (i.e., the leachate) may be discharged out of the apparatus for filtration through the outlet of the filtration layer 310. As another example, there may be two flow-through layers 320 and two filtration layers 310, e.g., the flow-through layer 320 includes a flow-through layer 320-1 and a flow-through layer 320-2, the filtration layer 310 includes a filtration layer 310-1 and filtration layer 310-2, and the filtration layer 310-2, the flow-through layer 320-2, the filtration layer 310-1, and the flow-through layer 320-1 are coaxially disposed in sequence along a radial direction of the apparatus 300 for filtration outwardly. The flow-through layer 320-1 is connected to the filtration layer 310-1 only, so that the liquid in the flow-through layer 320-1 may flow to the filtration layer 310-1 to be filtered through the filtration layer 310-1, and the since the flow-through layer 320-2 is connected to the filtration layer 310-1 and the filtration layer 310-2 at the same time, the liquid in the flow-through layer 320-2 may flow to the filtration layer 310-1 and the filtration layer 310-2, respectively, and be filtered through the filtration layer 310-1 and the filtration layer 310-2, and then leachates in the filtration layer 310-1 and the filtration layer 310-2 may be discharged out of the apparatus for filtration through outlets of the filtration layer 310-1 and the filtration layer 310-2, respectively. In some embodiments, the count of the filtration layer 310 and/or the flow-through layer 320 may be three, four, five, or more, which will not be repeated herein.

In some embodiments, a specific shape of the apparatus 300 for filtration may be related to a specific shape of an annular structure enclosed by the filtration layer 310 and the flow-through layer 320. For example, if the annular structure enclosed by the filtration layer 310 and the flow-through layer 320 is cylindrical, the apparatus 300 for filtration may be cylindrical. As another example, if the annular structure enclosed by the filtration layer 310 and the flow-through layer 320 is prismatic, the apparatus 300 for filtration may be prismatic. In some embodiments, the shape of the annular structure enclosed by the filtration layer 310 and the flow-through layer 320 may be a regular or irregular shape such as a cylinder, a prism, an ellipse, or the like.

In some embodiments, as shown in FIG. 19 and FIG. 20, the apparatus for filtration (e.g., the apparatus 100 for filtration in FIG. 1) may also include the liquid-dispensing component 470. The liquid-dispensing component 470 may be disposed at the inlet end and/or the retention end of the apparatus for filtration. When the liquid-dispensing component 470 is located at the inlet end of the apparatus for filtration, it is used to dispense the liquid entering the apparatus for filtration to ensure that the liquid is uniformly dispensed into each first flow channel (e.g., the at least one first flow channel 122 in FIG. 1). Then, the liquid may enter the filtration layer (e.g., the filtration layer 110 in FIG. 1) via the first flow channel, and then be filtered by the filtration membrane (e.g., the filtration membrane 111 in FIG. 1) of the filtration layer. This setup delays the accumulation and concentration polarization of substances retained by the filtration membrane on its surface, prevents the clogging of the filtration membrane caused by the tangential flow of the liquid, and ensures full contact between the liquid and the surface of the filtration membrane. This increases a contact area between the liquid and the filtration membrane surface, greatly enhancing filtration efficiency and significantly improving filtration performance. Additionally, it avoids altering the shape of the flow-through channel, thereby reducing shear forces on the liquid and significantly minimizing damage to active substances in a liquid that has been filtered. When the liquid-dispensing component 470 is disposed at the retention end of the apparatus for filtration, it is used to collect the retention liquid discharged from the retention end of the apparatus for filtration. By utilizing the liquid-dispensing component located at the retention end of the apparatus for filtration to collect the retention liquid discharged from the retention end of the apparatus for filtration, damage to active substances in the retention liquid may be reduced as well.

In some embodiments, the liquid-dispensing component 470 may include a liquid main pipe 471, a plurality of liquid diverters 472, and a housing 473. The plurality of liquid diverters 472 are spaced apart within the housing 473 along a height direction of the housing 473, and an interior of the housing 473 is in flow communication with an external pipeline through the liquid main pipe 471. Along the height direction of the housing 473, a cross-sectional area of a side of each of the plurality of liquid diverters 472 away from the liquid main pipe 471 is larger than a cross-sectional area of a side of each of the plurality of liquid diverters 472 close to the liquid main pipe 471.

The height direction of the housing 473 refers to a center axis direction of an opening of the housing 473 in flow communication with the liquid main pipe 471. The height direction of the housing 473 is indicated by arrows in FIG. 19 and FIG. 20. A cross-section of the liquid diverter 472 refers to a cross-section of the liquid diverter 472 perpendicular to the height direction of the housing 473. The liquid main pipe 471 is in flow communication with the external pipeline for transmitting the liquid into the housing 473 or collecting the retention liquid from the housing 473. For example, the liquid main pipe 471 may be in flow communication with a liquid pump (not shown in the figures). As another example, the liquid main pipe 471 may be in flow communication with a waste tank.

In some embodiments, the liquid-dispensing component 470 may further include a first liquid-drainage 474, and the first liquid-drainage 474 is disposed on a side of the plurality of liquid diverters 472 close to the liquid main pipe 471. The first liquid-drainage 474 may be used to drain liquid from the liquid main pipe 471 into the housing 473 to the plurality of liquid diverters 472.

In some embodiments, along the height direction of the housing 473, a cross-sectional area of a side of the first liquid-drainage 474 away from the liquid main pipe 471 is larger than a cross-sectional area of a side of the first liquid-drainage 474 close to the liquid main pipe 471. In some embodiments, the first liquid-drainage 474 may include a cone (e.g., a cone, a prismatic cone), a trapezoidal table, a round table, or the like. For example, in the embodiment shown in FIG. 19, the first liquid-drainage 474 is a cone, and a projection (e.g., a black area corresponding to dashed lines 476) of the first liquid-drainage 474 on an end surface of the retention end and/or the inlet end of the apparatus for filtration is circular. When contacting with the cone, the liquid may flow from a top portion to a bottom portion of the cone along a side wall of the cone, which causes the liquid to be dispersed and thus enables a portion of the liquid to be drained to the liquid diverter 472.

In some embodiments, the liquid-dispensing component 470 may also include a second liquid-drainage 475, and the second liquid-drainage 475 may be disposed on a side of the first liquid-drainage 474 away from the liquid main pipe 471. The second liquid-drainage 475 may be coaxially disposed with the first liquid-drainage 474. In some embodiments, by providing the second liquid-drainage 475 below the first liquid-drainage 474, the liquid between the first liquid-drainage 474 and a first liquid diverter 4721 may be prevented from directly falling below the first liquid-drainage 474, which causes uneven distribution of the liquid. In some embodiments, along the height direction of the housing 473, a cross-sectional area of a side of the second liquid-drainage 475 away from the liquid main pipe 471 is larger than a cross-sectional area of a side of the second liquid-drainage 475 close to the liquid main pipe 471. In some embodiments, the second liquid-drainage 475 may be the same as or similar to the first liquid-drainage 474.

In some embodiments, the liquid diverter 472 may be a non-closed structure. Merely by way of example, each liquid diverter 472 may include a plurality of diverting bars (not shown in the drawings), and along the height direction of the housing 473, a cross-sectional area of a side of each of the plurality of diverting bars away from the liquid main pipe 471 is larger than a cross-sectional area of a side of each of the plurality of diverting bars close to the liquid main pipe 471, and the plurality of diverting bars are disposed at an interval. In some embodiments, the cross-sectional shape of the diverting baffle perpendicular to the length direction of the diverting baffle may be triangular, trapezoidal, etc. In some embodiments, the length direction of the plurality of diverting bars may be perpendicular to the height direction of the housing 473, and the plurality of diverting bars may be disposed at an interval and parallel to each other along the height direction of the housing 473. In some embodiments, the plurality of diverting bars may be disposed coplanarly, and the plurality of diverting bars may be disposed on a plane that is perpendicular to the height direction of the housing 473. In some embodiments, the plurality of diverting bars may be disposed coplanarly, and an angle between the plane on which the plurality of diverting bars are located and the height direction of the housing 473 may be less than 90°. In some embodiments, the plurality of diverting bars may be disposed non-coplanarly.

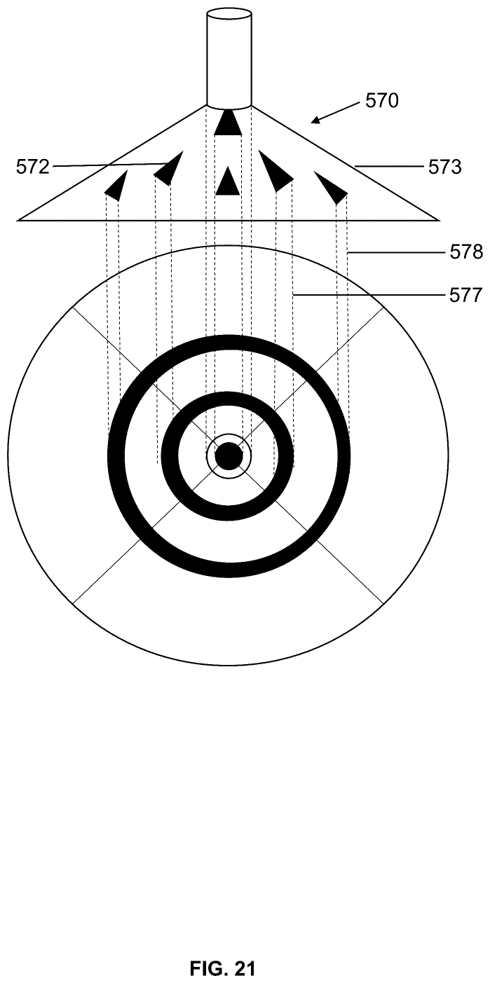

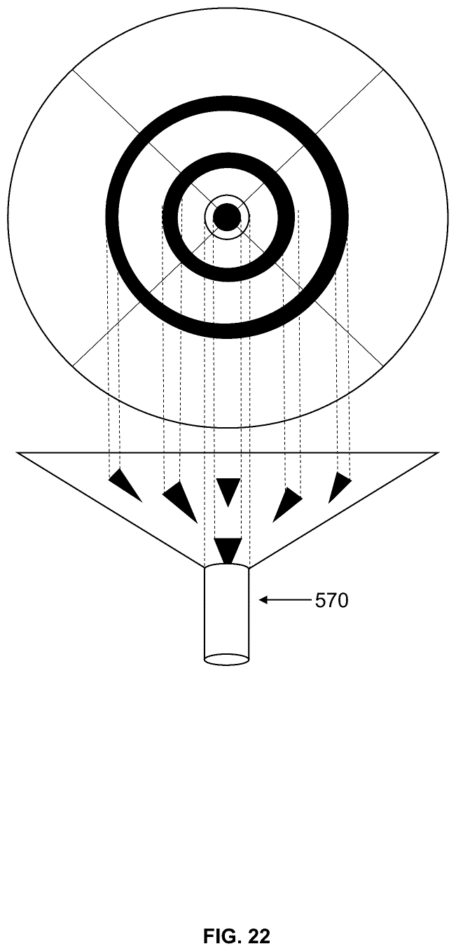

In some embodiments, the liquid diverter 472 may be one or more liquid-diverting rings coaxially disposed. In some embodiments, an axial direction of the liquid-diverting rings may be parallel to the height direction of the housing 473. The axial direction of the liquid-diverting rings refers to an axial direction that perpendicular to a plane enclosed by the liquid-diverting rings. In some embodiments, an angle between the axial direction of the liquid-diverting rings and the height direction of the housing 473 may be less than 90°. For example, the angle between the axial direction of the liquid-diverting rings and the height direction of the housing 473 is 30°. In some embodiments, each of the liquid-diverting rings may be a regular or irregularly-shaped ring structure such as a rectangular ring, a circular ring, a triangular ring, or the like. For example, in the embodiment shown in FIG. 19 and FIG. 20, the liquid diverter 472 is a rectangular ring, and a projection (e.g., a black area corresponding to dashed lines 477 and dashed lines 478) of the liquid diverter 472 on the end surface of the retention end and/or the inlet end of the apparatus for filtration is a rectangular ring. As another example, in embodiments shown in FIG. 21 and FIG. 22, the liquid diverter 572 is a circular ring, and a projection (e.g., a black area corresponding to dashed lines 577 and dashed lines 578) of the liquid diverter 572 on the end surface of the retention end and/or the inlet end of the apparatus for filtration is a circular ring. In some embodiments, along the height direction of the housing 473, an inner cross-sectional area of a side of the one or more liquid-diverting rings away from the liquid main pipe 471 is larger than an inner cross-sectional area of a side of the one or more liquid-diverting rings close to the liquid main pipe 471.

In some embodiments, a count of the liquid diverters 472 may be increased or decreased to meet the needs of liquid-dispensing in different scenarios. For example, if an area of the end surface of the inlet end and/or the retention end of the apparatus for filtration is increased (or a count of the first flow channels is increased), the count of the liquid diverters 472 may be increased. As another example, if the area of the end surface of the inlet end and/or the retention end of the apparatus for filtration is reduced (or the count of the first flow channels is reduced), the count of the liquid diverters 472 may be reduced, for example, the count of the liquid diverters 472 may be reduced to one.

In some embodiments, at least one first drainage channel 479 is formed between an outer wall surface of the first liquid-drainage 474 and an inner wall surface of the liquid diverter 472, between an outer wall surface and an inner wall surface of two adjacent liquid diverters 472, and between the liquid diverter 472 and an inner wall surface of the housing 473, and a first opening of the first drainage channel 479 is in flow communication with the liquid main pipe 471, and a second opening of the first drainage channel 479 corresponds to the end surface of the inlet end and/or the retention end of the apparatus for filtration.

The first drainage channel 479 corresponding to the end surface of the inlet end and/or the retention end of the apparatus for filtration refers to that when the liquid-dispensing component 470 is located at the inlet end and/or the retention end of the apparatus for filtration, a projection of the first drainage channel 479 covers at least a portion of the end surface of the inlet end and/or the retention end of the apparatus for filtration. The liquid flowing from the second opening of the first drainage channel 479 may flow to an area corresponding to the end surface of the inlet end and/or the retention end of the apparatus for filtration, or a liquid flowing from the end surface of the retention end and/or the inlet end of the apparatus for filtration may flow to a corresponding second opening of the first drainage channel 479. In some embodiments, the first drainage channel 479 formed between the outer wall surface of the first liquid-drainage 474 and the inner wall surface of the liquid diverter 472 may be referred to as a first sub-drainage channel 4791, and the first drainage channel 479 formed between the outer wall surface and the inner wall surface of the two adjacent liquid diverters 472 may be referred to as a second sub-drainage channel 4792, and the first drainage channel 479 formed between the liquid diverter 472 and the inner wall surface of the housing 473 may be referred to as a third sub-drainage channel 4793. The first sub-drainage channel 4791, the second sub-drainage channel 4792, and the third sub-drainage channel 4793 correspond to a portion of a region of the end surface of the inlet end and/or the retention end of the apparatus for filtration, respectively. It should be noted that the embodiments illustrated in FIG. 19 to FIG. 20 and FIG. 21 to FIG. 22 are for illustrative purposes only, and are not intended to limit a court of the first drainage channel, in actual application, a count of the sub-drainage channels may also be increased or decreased as required by a width of the apparatus for filtration. For example, when the area of the end surface of the inlet end and/or the retention end of the apparatus for filtration increases, a fourth sub-drainage channel, a fifth sub-drainage channel or the like may be added, for example, an end of a sub-drainage channel closest to the apparatus for filtration corresponds to a portion of the end surface of the inlet end and/or the retention end of the apparatus for filtration, respectively.

FIG. 19 is a schematic diagram illustrating a liquid-dispensing component 470 including two liquid diverters 472. For ease of description, the liquid diverter 472 close to the liquid main pipe 471 may be referred to as a first liquid diverter 4721, and the other liquid diverter 472 is referred to as a second liquid diverter 4722. As shown in FIG. 19, the first liquid diverter 4721 and the second liquid diverter 4722 are both rectangular rings, and the first liquid-drainage 474 is a cone. The farther away from the liquid main pipe 471, the larger the cross-sectional area of the cone and the thicker the wall of each rectangular ring. Taking the liquid-dispensing component 470 disposed at the inlet end of the apparatus for filtration as an example, when the liquid flows into the housing 473 from the liquid main pipe 471, a portion of the liquid may flow to the first liquid-drainage 474 and contact with the first liquid-drainage 474, the liquid may be diverted by the first liquid-drainage 474, and a portion of the liquid that is diverted by the first liquid-drainage 474 may flow from an outer side of the first liquid-drainage 474 (i.e., the first sub-drainage channel 4791 formed between the first liquid-drainage 474 and the first liquid diverter 4721) to the end surface of the inlet end of the apparatus for filtration, and another portion of the liquid may be drained to the first liquid diverter 4721. The liquid flowing to the first liquid diverter 4721 may be diverted by the first liquid diverter 4721. A portion of the liquid that is diverted by the first liquid diverter 4721 may flow from an inner side of the first liquid diverter 4721 (i.e., the first sub-drainage channel 4791) to the apparatus for filtration, while another portion of the liquid may flow from an outer side of the first liquid diverter 4721 (i.e., the second sub-drainage channel 4792 formed between the second liquid diverter 4722 and the first liquid diverter 4721) to the apparatus for filtration. In turn, a portion of the liquid flowing down from the outer side of the first liquid diverter 4721 may flow toward the second liquid diverter 4722 and contacts the second liquid diverter 4722. Therefore, this portion of the liquid (i.e., the liquid flowing to the second liquid diverter 4722) may be diverted by the second liquid diverter 4722 and may flow to the inlet end of the apparatus for filtration from an inner side (i.e., the second sub-drainage channel 4792) and an outer side (i.e., the third sub-drainage channel 4793 formed between the second liquid diverter 4722 and the housing 473) of the second liquid diverter 4722, respectively.

In some embodiments, along the height direction of the housing 473, an inner cross-sectional area of a side of the housing 473 away from the liquid main pipe 471 is larger than an inner cross-sectional area of a side of the housing 473 close to the liquid main pipe 471. In some embodiments, a projection of the housing 473 at the retention end and/or at the inlet end of the apparatus for filtration may correspond to the shape of the end surface of the retention end and/or the inlet end of the apparatus for filtration. For example, in the embodiments illustrated in FIG. 19 and FIG. 20, the end surface of the retention end and/or the inlet end of the apparatus for filtration is rectangular, and therefore the projection of the housing 473 on the retention end and/or the inlet end of the apparatus for filtration is also rectangular. That is, the liquid-dispensing component 470 illustrated in FIG. 19 to FIG. 20 may be adapted to an apparatus for filtration whose end surfaces of a retention end and/or an inlet end is rectangular. For example, the apparatus 100 for filtration in FIG. 1 to FIG. 3 is a plate-like structure, so end surfaces of the retention end and/or the inlet end of the apparatus 100 for filtration are rectangular. As another example, the apparatus 200 for filtration in FIG. 11 to FIG. 13 is a plate-like structure, so end surfaces of the retention end and/or the inlet end of the apparatus 200 for filtration are rectangular. For example, in the embodiments shown in FIG. 21 and FIG. 22, end surfaces of the retention end and/or the inlet end of the apparatus for filtration are circular, and therefore the projection of the housing 473 on the retention end and/or the inlet end of the apparatus for filtration is also circular. That is, a liquid-dispensing component 570 illustrated in FIG. 21 and FIG. 22 may be adapted for an apparatus for filtration whose end surfaces of a retention end and/or an inlet end is a circular or similar to circular, for example, the apparatus 300 for filtration in FIG. 14 to FIG. 18 is a structure similar to cylinder, so that end surfaces of the retention end and/or the inlet end of the apparatus 300 for filtration are similar to circular.

In some embodiments, except for a shape of the housing and the liquid diverter, the liquid-dispensing component 570 of the embodiment illustrated in FIG. 21 and FIG. 22 is identical or similar to the liquid-dispensing component 470 of the embodiment shown in FIG. 19 and FIG. 20, which will not be repeated herein.

In some embodiments, the liquid-drainage 474 and the plurality of liquid diverters 472 may be connected to the housing 473. For example, as shown in FIG. 19, the housing of the apparatus for filtration (not shown in the figure) is provided with a fixing bracket 4701, which may be used to fix the housing relative to the liquid-dispensing component 470. In some embodiments, the liquid-drainage 474 and the plurality of liquid diverters 472 may be removably connected or fixedly connected to the housing 473, and a removable connection or a fixed connection may be referred to descriptions of other embodiments.

FIG. 20 is a schematic diagram illustrating an exemplary liquid-dispensing component placed at a second angle according to some embodiments of the present disclosure. A placement direction of the liquid-dispensing component 470 shown in FIG. 20 may be opposite to a placement direction of the liquid-dispensing component 470 shown in FIG. 19. In some embodiments, the liquid-dispensing component 470 may be placed at a first angle or a second angle when there is a need to dispense the liquid to the apparatus for filtration. For example, the liquid-dispensing component 470 is placed at the second angle, where the apparatus for filtration may be disposed above the liquid-dispensing component 470, and an end surface of an inlet end of the apparatus for filtration may correspond to an opening of the housing 473. The liquid main pipe 471 of the liquid-dispensing component 470 is in flow communication with a liquid pump, through which the liquid is pumped into the housing 473, and in turn, the liquid is transmitted to the inlet end of the apparatus for filtration by the liquid-dispensing component 470.

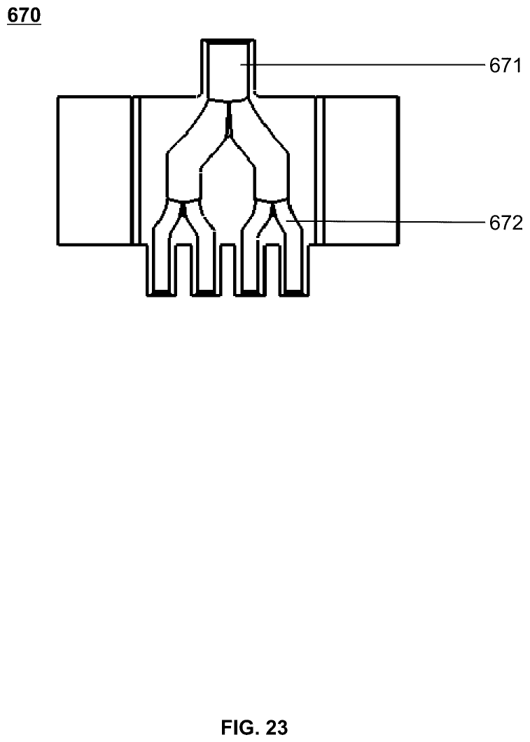

In some embodiments, as shown in FIG. 23, a liquid-dispensing component 570 may include a liquid main pipe (not shown in the figure) and at least one liquid branch pipe. One of the at least one liquid branch pipe includes a first opening and a plurality of second openings. An end of the liquid main pipe is connected to the first opening of the liquid branch pipe, the other end of the liquid main pipe is connected to an external pipeline, and the second openings of the liquid branch pipe correspond to an end surface of at least one of the inlet end and/or the retention end of the apparatus for filtration. In some embodiments, as shown in FIG. 23, the liquid branch pipe may include a first liquid branch pipe 671 and at least one second liquid branch pipe 672, the first liquid branch pipe 671 and the at least one second liquid branch pipe 672 both include a first opening and a plurality of second openings. The first opening of the first liquid branch pipe 671 may be connected to an end of the liquid main pipe the first opening of the at least one second liquid branch pipe 672 may be correspondingly connected to a second opening of the first liquid branch pipe 671. Each of the second openings of the at least one second liquid branch pipe 672 may correspond to the end surface of the inlet end and/or the retention end of the apparatus for filtration. It should be noted that an embodiment shown in FIG. 23 is for illustrative purposes only, and does not limit a count of the liquid branch pipe, and in practice, the count of the liquid branch pipe may also be increased or decreased as required by a width of the apparatus for filtration. For example, when the end surface of the inlet end and/or the retention end of the apparatus for filtration is enlarged, for example, a third liquid branch pipe, a fourth liquid branch pipe, a fifth liquid branch pipe, etc., may be added. A connection manner between liquid branches pipes at each level is similar to that of the first liquid branch pipe and the second liquid branch pipe, and a second opening of the liquid branch pipe closest to the apparatus for filtration corresponds to the end surface of the inlet end and/or the retention end of the apparatus for filtration.

The first opening of the second liquid branch pipe 672 corresponding to a second opening of the first liquid branch pipe 671 refers to that the first opening of the second liquid branch pipe 672 is connected to the second opening of one first liquid branch pipe 671. The count of the first opening of the second liquid branch pipe 671 is the same as the count of the second opening of the first liquid branch pipe 671. Since each of the first liquid branch pipe 671 and the second liquid branch pipe 672 includes a plurality of second openings, when the liquid flows out of the first liquid branch pipe 671 and/or the second liquid branch pipe 672, the liquid may be split into a plurality of liquids. In some embodiments, inner diameters of the second openings of the first liquid branch pipe 671 are the same, and inner diameters of the plurality of second openings of the at least one second liquid branch pipe 672 are the same.

In this embodiment, when the liquid-dispensing component 670 is disposed at the inlet end of the apparatus for filtration, the liquid, after flowing into the first liquid branch pipe 671, may then flow into the at least one second liquid branch pipe 672 from the second openings of the first liquid branch pipe 671, respectively. Then the liquid in each second liquid branch pipe 672 may in turn flow out of the plurality of second openings of the at least one second liquid branch pipe 672 and into the first flow channel, thereby completing the distribution of the liquid.

Merely by way of example, as shown in FIG. 23, a count of the first liquid branch pipe 671 is one, a count of the second liquid branch pipe 672 is two, the second openings of the first liquid branch pipe 671 and the second openings of the second liquid pipe 672 are both two, and the first opening of each of the two second liquid branch pipes 672 are connected to one of the second openings of the first liquid branch pipe 671, respectively. Each of the second openings of the two second liquid branch pipes 672 corresponds to the end surface of the inlet end and/or the retention end of the apparatus for filtration (not shown in the figures), respectively.

It should be noted that a structure of the liquid-dispensing component 670 illustrated in FIG. 23 is for illustrative purposes only, and is not intended to limit a count and a shape of the liquid branch pipe. In some embodiments, the count of the liquid branch pipe may be increased or decreased to meet the needs of liquid dispensing. For example only, when an area of the end surface of the inlet end and/or the retention end of the apparatus for filtration is increased or a count of the first flow channel is increased, a third liquid branch pipe, a fourth liquid branch pipe, a fifth liquid branch pipe, and so forth, may be added, and liquid branch pipes at each level may be connected in a similar manner as that of between the first liquid branch pipe and the second liquid branch pipe, and a second opening of a liquid branch pipe that is closest to the apparatus for filtration corresponds to the end surface of the inlet end and/or the retention end of the apparatus for filtration. As another example, the second liquid branch pipe 672 may be omitted when the area of the end surface of the inlet end and/or the retention end of the apparatus for filtration decreases or the count of the first flow channel decreases. In some embodiments, the first liquid branch pipe 671 and the second liquid branch pipe 672 may be a round pipe, a square pipe, or the like.

In some embodiments, connecting faces of the plurality of second openings of the first liquid branch pipe 671, connection faces of the plurality of second openings of the second liquid branch pipe 672, and a connection face between the first liquid branch pipe 671 and the second liquid branch pipe 672 may be curved to reduce a shear force and frictional resistance subjected by the liquid as the liquid passes through the faces, thereby preventing substances in the liquid (e.g., cells) from being damaged, e.g., to reduce damage to cells and increase cell activity.

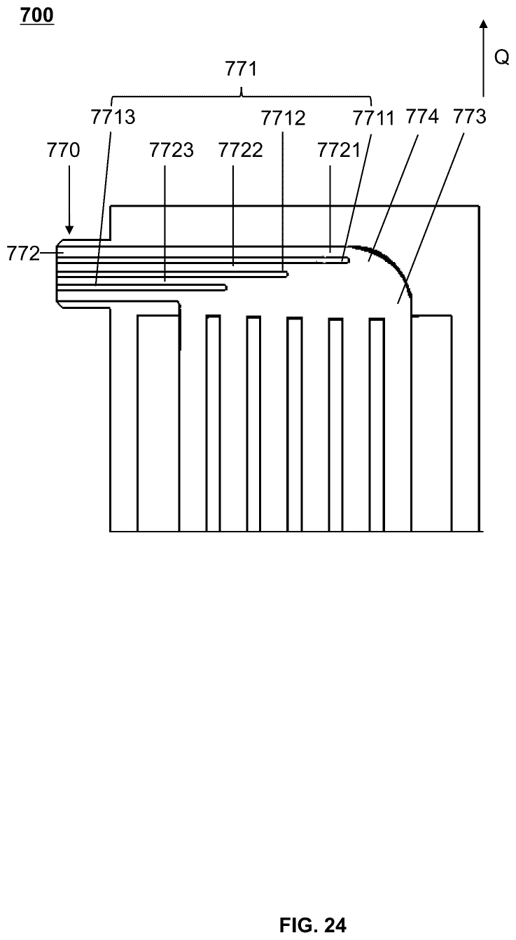

In some embodiments, as shown in FIG. 24, a liquid-dispensing component 770 may include a liquid main pipe (not shown in the figure), a port 773, a drainage pipe 774, and at least one liquid-diverting baffle 771, the port 773 may be disposed on a side of the drainage pipe 774, one end of the drainage pipe 774 may be connected to a liquid main pipe, and the liquid-diverting baffle 771 may be disposed within the drainage pipe 774. The liquid-diverting baffle 771 divides a second drainage channel 772 within the drainage pipe 774. The second drainage channel 772 is in flow communication with the liquid main pipe and the port 773. In this embodiment, the second drainage channel 772 may be provided in correspondence with an inlet end and/or a retention end of an apparatus 700 for filtration via the port 773 of the liquid-dispensing component 770, so the liquid may be transmitted to the inlet end of the apparatus 700 for filtration and/or a liquid (e.g., a retention liquid) discharged out of the retention end may enter the liquid-dispensing component 770.

In some embodiments, there may be one second drainage channel 772. For example, there may be one liquid-diverting baffle 771, and a surface of the liquid-diverting baffle 771 back from the port 773 may define and space the second drainage channel 772. In some embodiments, there may be a plurality of second drainage channels 772, and the plurality of second drainage channels 772 may be inconsistent in length. In some embodiments, a length of each of the plurality of second drainage channels 772 increases along a direction from close to the port 773 to away from the port 773. Merely by way of example, there may be a plurality of liquid-diverting baffles 771 disposed at an interval along the direction from close to the port 773 to away from the port 773, and a length of each of the plurality of liquid-diverting baffles 771 may be increased along an extension direction of the drainage pipe 774, the plurality of liquid-diverting baffles 771 may divide the drainage pipe 774 into a plurality of second drainage channels 772, and lengths of the plurality of second drainage channels 772 may increase along the direction from close to the port 773 to away from the port 773. In some embodiments, the direction from close to the port 773 to away from the port 773 of the liquid-dispensing component 770 refers to a direction indicated by an arrow Q in FIG. 24.

In some embodiments, the plurality of liquid-diverting baffles 771 are disposed at an interval and parallel. For example, the plurality of liquid-diverting baffles 771 may be provided at an interval and parallel along the direction indicated by the arrow Q. The plurality of liquid-diverting baffles 771 divide the drainage pipe 774 into a plurality of second drainage channels 772, and the plurality of second drainage channels 772 are parallel to each other. As another example, the plurality of liquid-diverting baffles 771 are parallel to each other and are all disposed at an angle to the end surface of the inlet end and/or the retention end of the apparatus 700 for filtration. In some embodiments, two adjacent liquid-diverting baffles 771 may be provided at an angle. For example, an end of one of the two adjacent liquid-diverting baffles 771 (i.e., an end of the liquid-diverting baffle 771 away from the liquid main pipe) may be angled toward an end of the other liquid-diverting baffle 771, such that an angle greater than 0° and less than 90° is formed between two adjacent second drainage channels 772.

FIG. 24 is a schematic diagram illustrating a liquid-dispensing component 770 disposed at an inlet end of an apparatus 700 for filtration. As shown in FIG. 24, there are three liquid-diverting baffles 771 parallel to each other. The three liquid-diverting baffles 771 divide the drainage pipe 774 into a plurality of second drainage channels 772. For ease of description, the liquid-diverting baffle 771 farthest from the port 773 may be referred to as a first liquid-diverting baffle 7711, the liquid-diverting baffle 771 closest to the port 773 may be referred to as a third liquid-diverting baffle 7713, and the liquid-diverting baffle 7711 between the third liquid-diverting baffle 7713 and the first liquid-diverting baffle 7711 may be referred to as the second liquid-diverting baffle 7712. A second drainage channel 772 (which may be referred to as a fourth sub-drainage channel 7721) is formed on a side of the first liquid-diverting baffle 7711 that is back from the second liquid-diverting baffle 7712, a second drainage channel 772 (which may be referred to as a fifth sub-drainage channel 7722) is formed between the first liquid-diverting baffle 7711 and the second liquid-diverting baffle 7712, a second drainage channel 772 (which may be referred to as a sixth sub-diversion channel 7723) is formed between the third liquid-diverting baffle 7713 and the second liquid-diverting baffle 7712. Along the direction from close to the port 773 to away from the port 773, the fourth sub-drainage channel 7721, the fifth sub-drainage channel 7722, the sixth sub-drainage channel 7723, the first liquid-diverting baffle 7711, the second liquid-diverting baffle 7712, and the third liquid-diverting baffle 7713 are all parallel to the end surface of the inlet end of the apparatus 700 for filtration. As lengths of the fourth sub-drainage channel 7721, the fifth sub-drainage channel 7722, and the sixth sub-drainage channel 7723 decrease sequentially along a direction away from the port 773 to close to the port 773, this can ensure that the liquid discharged from each of the second drainage channels 772 may be transmitted to the inlet end of the apparatus 700 for filtration or that a liquid discharged from the retention end (i.e., a retention liquid) may all flow into the second drainage channels 772. In some embodiments, on a side of the third liquid-diverting baffle 7713 backed away from the second liquid-diverting baffle 7712, a second drainage channel 772 may also be viewed to form, which may be referred to as a seventh sub-drainage channel, for example.

In some embodiments, the count of the liquid-diverting baffles 771 may be increased or decreased to meet the needs of liquid dispensing. Merely by way of example, the count of the liquid-diverting baffles 771 may be increased when a count of the first flow channel increases. As another example, the count of the liquid-diverting baffles 771 may be decreased when the count of the first flow channel decreases. In some embodiments, the liquid-diverting baffle 771 may be a flat plate, a wavy plate, a curved plate, or the like.

The present disclosure also provides a method for filtration based on an apparatus for filtration in the preceding embodiments (e.g., the apparatus 100 for filtration in FIG. 1 to FIG. 3, the apparatus 200 for filtration in FIG. 11 to FIG. 13, the apparatus 300 for filtration in FIG. 14 to FIG. 18). The method may include feeding a liquid through an inlet end of the apparatus for filtration; and collecting a retention liquid discharged from the retention end of the apparatus for filtration. The retention end of the apparatus for filtration in this embodiment refers to an opening on a flow-through layer, and after the liquid is filtered through the apparatus for filtration, the retention liquid that is retained in the flow-through layer may be discharged out of the apparatus for filtration through the opening on the flow-through layer. In some embodiments, a liquid-dispensing component (e.g., the liquid-dispensing component 470 in FIG. 19, the liquid-dispensing component 570 in FIG. 21, the liquid-dispensing component 670 in FIG. 23, or the liquid-dispensing component 770 in FIG. 24) may be disposed at the inlet end of the apparatus for filtration, and the liquid may be transmitted to the inlet end of the apparatus for filtration via the liquid-dispensing component. In some embodiments, the liquid-dispensing component may be provided at the retention end of the apparatus for filtration, and the retention liquid discharged from the retention end of the apparatus for filtration may be collected by the liquid-dispensing component.

The beneficial effects of the apparatus for filtration and the method for filtration for the apparatus for filtration provided in the present disclosure include, but are not limited to that: (1) since at least one flow-through layer is provided along a filtration direction of a filtration layer, a first support member may support a filtration membrane, establish one or more channels to guide a liquid to flow through a surface of the filtration membrane, and utilize the rigidity characteristics of the first support member, so that the first flow-through channel and the filtration membrane may not be obviously deformed during a filtration process, so that a diameter of the first flow channel may be well maintained, which in turn makes the liquid in the flow process subject to less resistance and perturbation, and is more close to a state of laminar flow, which greatly reduces a shear force on the liquid, and significantly reduces the damage to active substances in the liquid, e.g., reduces the destruction of the cells, and enhances the cells activity; (2) since two adjacent first flow channels in the same flow-through layer are divided by the first support member, each first flow channel is relatively independent, and may be used independently for the flow of the liquid, and the liquid in each first flow channel may not affect each other, so that the liquid in each first flow channel is more uniform, and it is more conducive to the tangential flow of the liquid along the surface of the filtration membrane, which slows down the accumulation and concentration polarization of the substances retained by the filtration membrane on the surface of the filtration membrane, avoids premature clogging of the filtration membrane and improves the filtration effect; (3) due to the flow-through layer, when the liquid enters the apparatus for filtration, it does not pass through the filtration membrane directly, but enters into the first flow channel first, and since resistance in the first flow channel is smaller, so the liquid is subjected to less resistance when flowing in the apparatus for filtration, which reduces a driving force required for the liquid to enter the apparatus for filtration, which in turn reduces the pressure of the liquid on the filtration membrane; (4) since an extension direction of the first flow channel is parallel to the surface of the filtration membrane, when the liquid flows in the first flow channel, it is equivalent to the flow along the surface of the filtration membrane, i.e., tangential flow, and the tangential flow may slow down the buildup of the material retained by the filtration membrane on the surface of the filtration membrane and concentration polarization, avoid premature clogging of the filtration membrane, and increases a contact area between the liquid and the surface of the filtration membrane, improving the filtration efficiency and the filtration effect; (5) by setting a liquid-dispensing component, and utilizing the liquid-dispensing component to transport the liquid to an inlet end of the apparatus for filtration, it is possible to ensure that the liquid is fed into various first flow channels, so that the liquid may be evenly distributed into the filtration layer via the first flow channel, and then be filtered by the filtration membrane on the filtration layer; in addition, the flow channel design in the liquid-dispensing component significantly reduces the shear force to the liquid, and thus reduces the damage to the active substances in the liquid, and by using the liquid-dispensing component placed at the retention end of the apparatus for filtration to collect a retention liquid discharged from the retention end of the apparatus for filtration may also reduce the damage to active substances in the retention liquid. The foregoing is only a preferred embodiment of the present disclosure, and is not intended to limit the present disclosure, and any modifications, equivalent substitutions, improvements, etc. made within the spirit and principles of the present disclosure shall be included in the scope of protection of the present disclosure.

What is claimed is:

1. An apparatus for filtration, comprising:
at least one filtration layer; and
at least one flow-through layer disposed along a filtration direction of the filtration layer;
wherein one of the at least one flow-through layer includes at least one first support member and at least one first flow channel, the at least one first flow channel is configured for a liquid to flow, and the at least one first support member defines the at least one first flow channel.

2. The apparatus for filtration of claim 1, wherein a retention end of the apparatus for filtration is in communication with the at least one flow-through layer, a retention liquid in the at least one flow-through layer is discharged through the retention end of the apparatus for filtration, and an inlet end of the apparatus for filtration is in flow communication with the at least one flow-through layer.

3. The apparatus for filtration of claim 1, wherein the at least one first support member includes a plurality of first support members spaced apart, and one of the at least one first flow channel is arranged between two adjacent first supporting members among the plurality of first support members; or
the at least one first support member is in a wavy plate-like structure, and one or more first grooves are disposed on both sides of the first supporting member along a thickness direction, and the one or more first grooves define the at least one first flow channel.

4. The apparatus for filtration of claim 1, wherein the at least one first flow channel includes a plurality of first flow channels, two adjacent first flow channels of the plurality of first flow channels are separated by one of the at least one first support member, the first support member is provided with a first communication pore, and the two adjacent first flow channels are in flow communication through the first communication pore.

5. The apparatus for filtration of claim 1, wherein the at least one filtration layer includes a filtration screen and one or more filtration membranes, one of the one or more filtration membranes includes at least one of a hollow fiber membrane, a plate membrane, or a rolled membrane, and the filtration screen supports the one or more filtration membranes.

6. The apparatus for filtration of claim 1, wherein
the at least one flow-through layer includes a plurality of flow-through layers, wherein one of the at least one filtration layer is disposed on each of both sides along a thickness direction of one of the plurality of flow-through layers; and/or
the at least one filtration layer includes a plurality of filtration layers, wherein one of the at least one flow-through layer is disposed on each of both sides of one of the plurality of filtration layers along a filtration direction of the one of the at least one filtration layer.

7. The apparatus for filtration of claim 1, wherein the apparatus for filtration is a columnar structure, the apparatus for filtration includes a filtrate discharge pipeline, the at least one filtration layer and the at least one flow-through layer are spirally encircled along a circumferential direction of the filtrate discharge pipeline and are alternately disposed along a radial direction of the filtrate discharge pipeline; and the filtrate discharge pipeline is provided with a collection pore passing through a side wall of the filtrate discharge pipeline; and
ends of the at least one flow-through layer and the at least one filtration layer away from the filtrate discharge pipeline along a spiral direction are both closed, an end of each of the at least one flow-through layer close to the filtrate discharge pipeline along the spiral direction is connected to the side wall of the filtrate discharge pipeline, and an end of each of the at least one filtration layer close to the filtrate discharge pipeline is in flow communication with the filtrate discharge pipeline through the collection pore.

8. The apparatus for filtration of claim 1, wherein the apparatus for filtration is a columnar structure, the apparatus for filtration includes a filtrate discharge pipeline, the filtrate discharge pipeline is provided with a collection pore passing through a side wall of the filtrate discharge pipeline; a plurality of filtration groups are provided apart along a circumferential direction of the filtrate discharge pipeline, and the plurality of filtration groups are spirally encircled along the circumferential direction of the filtration discharge pipeline; and each filtration group of the plurality of filtration groups includes one of the at least one filtration layer and one of the at least one flow-through layer connected to the at least one filtration layer; and
for each filtration group, ends of the flow-through layer and the filtration layer away from the filtrate discharge pipeline along a spiral direction are closed, an end of the flow-through layer close to the filtrate discharge pipeline along the spiral direction is connected to the side wall of the filtrate discharge pipeline, and an end of the filtration layer close to the filtrate discharge pipeline is in flow communication with the filtrate discharge pipeline through the collection pore.

9. The apparatus for filtration of claim 1, wherein the apparatus for filtration is a columnar structure, each of the at least one filtration layer and the at least one flow-through layer of the apparatus for filtration is an annular structure, and the at least one filtration layer and the at least one flow-through layer are coaxially disposed.

10. The apparatus for filtration of claim 1, further comprising at least one permeable layer disposed along the filtration direction of the at least one filtration layer, one of the at least one permeable layer is provided with at least one second support member and at least one second flow channel, and the at least one second support member defines the at least one second flow channel.

11. The apparatus for filtration of claim 10, wherein the at least one second support member includes a plurality of second support members spaced apart, and one of the at least one second flow channel is defined between two adjacent second supporting members among the plurality of second support members, each of the second support members is provided with at least one second communication pore, and the at least one second communication pore is in flow communication with two adjacent second flow channels.

12. The apparatus for filtration of claim 1, further comprising at least one liquid-dispensing component, wherein one of the at least one liquid-dispensing component is disposed at an inlet end of the apparatus for filtration or a retention end of the apparatus for filtration.

13. The apparatus for filtration of claim 12, wherein the liquid-dispensing component includes a liquid main pipe, a plurality of liquid diverters, and a housing;
the plurality of liquid diverters are spaced apart in the housing along a height direction of the housing, and along the height direction of the housing, a cross-sectional area of a side of each of the plurality of liquid diverters away from the liquid main pipe is larger than a cross-sectional area of a side of each of the plurality of liquid diverters close to the liquid main pipe; and
an external pipeline is in flow communication with an interior of the housing through the liquid main pipe.

14. The apparatus for filtration of claim 13, wherein the liquid-dispensing component further includes a first liquid-drainage, the first liquid-drainage is disposed on the side of the plurality of liquid diverters close to the liquid main pipe, and along the height direction of the housing, a cross-sectional area of a side of the first liquid-drainage away from the liquid main pipe is larger than a cross-sectional area of a side of the first liquid-drainage close to the liquid main pipe.

15. The apparatus for filtration of claim 13, wherein one of the liquid diverters includes a plurality of diverting bars, along the height direction of the housing, a cross-sectional area of a side of each of the plurality of diverting bars away from the liquid main pipe is larger than a cross-sectional area of a side of each of the plurality of diverting bars close to the liquid main pipe; and
the plurality of diverting bars are spaced apart along the height direction of the housing.

16. The apparatus for filtration of claim 13, wherein the plurality of liquid diverters are a plurality of liquid-diverting rings, the plurality of liquid-diverting rings are coaxially disposed,
an angle between the axial direction of the liquid-diverting ring and the height direction of the housing is less than 90°.

17. The apparatus for filtration of claim 12, wherein the liquid-dispensing component includes a liquid main pipe and at least one liquid branch pipe;
one of the at least one liquid branch pipe includes a first opening and a plurality of second openings; and
an end of the liquid main pipe is connected to the first opening of the liquid branch pipe, the other end of the liquid main pipe is connected to an external pipeline, and the plurality of second openings of the liquid branch pipe correspond to an end surface of at least one of the inlet end of the apparatus for filtration or the retention end of the apparatus for filtration.

18. The apparatus for filtration of claim 12, wherein the liquid-dispensing component includes a liquid main pipe, a drainage pipe, a port, a plurality of liquid-diverting baffles, the port is disposed at a side portion of the drainage pipe, an end of the drainage pipe is connected to the liquid main pipe, the plurality of liquid-diverting baffles are disposed inside the drainage pipe and spaced apart along a direction from close to the port to away from the port, and a length of each of the plurality of liquid-diverting baffles along an extension direction of the drainage pipe increases along the direction from close to the port to away from the port; and the plurality of liquid-diverting baffles define a plurality of second drainage channels inside the drainage pipe; and
each of the plurality of second drainage channels is in flow communication with the liquid main pipe and the port, and the port corresponds to at least one of the inlet end of the apparatus for filtration or the retention end of the apparatus for filtration.

19. A method for filtration, comprising:
feeding a liquid through an inlet end of an apparatus for filtration; and
collecting a retention liquid discharged from a retention end of the apparatus for filtration.

20. The filtration method of claim 19, wherein the feeding a liquid through an inlet end of an apparatus for filtration includes:
disposing a liquid-dispensing component at the inlet end of the apparatus for filtration;
transporting the liquid to the inlet end of the apparatus for filtration through the liquid-dispensing component; and/or
the collecting a retention liquid discharged from a retention end of the apparatus for filtration includes:
disposing the liquid-dispensing component at the retention end of the apparatus for filtration; and
collecting the retention liquid discharged from the retention end of the apparatus for filtration through the liquid-dispensing component.
